(19) United States
(12) Patent Application Publication
(10) Pub. No.: US 2012/0331098 A1
(43) Pub. Date: Dec. 27, 2012

(54) BEHAVIORAL NETWORKING SYSTEMS AND METHODS FOR FACILITATING DELIVERY OF TARGETED CONTENT

(75) Inventors: Kent Thomas Ertugrul, London (GB); Anton Roslov, London (GB)

(73) Assignee: PHORM UK, INC., London (GB)

(21) Appl. No.: 13/490,231

(22) Filed: Jun. 6, 2012

Related U.S. Application Data
(63) Continuation of application No. 12/348,845, filed on Jan. 5, 2009, now abandoned.
Application No. 12/348,845 is a continuation of application No. 11/683,891, filed on Mar. 8, 2007, now abandoned.
(60) Provisional application No. 60/876,886, filed on Dec. 22, 2006.

(51) Int. Cl. G06F 15/16

(52) U.S. Cl. 709/217

(57) ABSTRACT

A method of providing targeted content includes obtaining behavioral information from client devices or client device users in a networked environment, and causing content (e.g., advertising) to be selected and delivered to a client device based on behavioral information. According to the method, a plurality of service providers each participate in monitoring network activities of client devices that connect to a network through such service providers. Information derived from the network activities is collected and rules are applied to the information to identify a user to receive the targeted content. The targeted content is thereupon provided to a client device associated with the identified user.

### CROSS-REFERENCE TO RELATED APPLICATIONS

This application is a continuation of and claims priority to U.S. patent application Ser. No. 12/348,845 of Kent Thomas Ertugrul and Anton Roslov for BEHAVIORAL NETWORKING SYSTEMS AND METHODS FOR FACILITATING DELIVERY OF TARGETED CONTENT, filed Jan. 5, 2009, which is a continuation of and claims priority to U.S. patent application Ser. No. 11/683,891 of Kent Thomas Ertugrul and Anton Roslov for BEHAVIORAL NETWORKING SYSTEMS AND METHODS FOR FACILITATING DELIVERY OF TARGETED CONTENT, filed Mar. 8, 2007, which claims priority from U.S. Provisional Patent Application No. 60/876,886 of Kent Thomas Ertugrul and Anton Roslov for BEHAVIORAL NETWORKING SYSTEMS AND METHODS FOR FACILITATING DELIVERY OF TARGETED CONTENT, filed Dec. 22, 2006, the entirety of each of which are hereby incorporated by reference for all purposes.

### BACKGROUND

The present disclosure relates to obtaining behavioral information from client devices or client device users in a networked environment, and causing content (e.g., advertising) to be selected and delivered to a client device based on behavioral information.

### SUMMARY OF THE INVENTION

The present invention is directed to methods of and systems for the comprehensive monitoring of user activities in connection with searches for and retrieval of information from a network, such as the Internet, and the coordinated collection of resultant behavioral information about users so as to supply targeted and/or customized content to each user. By providing for the collection of user data from plural service providers (e.g., Internet Service Providers or ISPs in an Internet context), select embodiments of the invention can facilitate an ability to provide customized content to users. According to one aspect of the invention, user activities can be monitored during the entirety of each user session without regard to the particular websites being accessed, search engines being used, or other specific resources employed. Information from monitoring each user session may come through the user's service provider, e.g., ISP. Thus, the whole of each user's experience from onset to termination of their network connection can be monitored. Information is collected from users of various ISPs, processed and used to generate an integrated database of user behavioral information. This behavioral information may be used to provide customized content to each user such as, for example, messages including advertising tailored to be of interest to each user.

Embodiments of the invention may include one or more of the following features (note that the examples presented below are by way of illustration only and are not intended as limiting):

Monitoring of client device activities across multiple network-access providers, e.g., in an Internet example, monitoring webpage content viewed (or context of content viewed) by users connected to the Internet through various ISPs;

Collecting information about each individual user derived from the monitored activities and applying rules to identify targeted information (e.g., advertising) for delivery to the user, e.g., identifying advertising content that is predicted to be of interest to a user based on prior web pages visited by the user or identify users to target to receive advertising or other content;

Providing the content to the user, e.g., displaying a television commercial using a settop box, causing a message (e.g., an advertisement) to appear within a browser window, etc.

Maintaining and/or providing access to a collection of channel definitions describing attributes and thresholds triggering identification of a user and/or group of users to receive specified targeted material, e.g. advertising.

According to one aspect of the invention, a method provides the intelligent identification and supply of information to an end user using extrinsic data associated with and/or a request initiated by the end user or client. The extrinsic data (e.g., data not explicitly included as part of an information retrieval request initiated by the user) may represent behavior of the user based on network activity of the client and may be collected for plural users employing multiple service providers (e.g., ISPs). In contrast to prior two-dimensional paradigms, i.e., those in which a content provider (e.g., web publisher) is only aware of communications between itself and its users, the present model incorporates a third dimension, i.e., awareness of the context of communications between users and multiple content providers visited by users aggregated across multiple ISPs. A repository of contextual information or user behavioral information collected from one or more service providers may be used to moderate activity and to tailor delivery of content based on predicted interests of the end users. Rather than limiting a response to information that is part of an information request initiated by the client (e.g., the information contained in a webpage explicitly identified by the user), various embodiments of the invention employ a multidimensional analysis of both the client and multiple content providers by providing a third dimension of specificity. This third dimension may be in the form of client behavior activities and information source requirements and/or rules to thereby provide additional retrieval criteria. Creation and access to rules matching clients and content may be managed by systems and methods within the scope of the invention.

Embodiments of the invention may be employed to provide message providers, such as advertisers, with methods and tools to target users or groups of users based on user access to contextually and/or behaviorally relevant pages across resources such as the web. These methods and tools further enable publishers, ISPs, advertisers and others to increase the contextual/behavioral relevancy of content for users. The users may be prospective consumers in which case these methods and tools can be applied to increase the relevancy of advertising placements resulting in increased sales and enhancing advertising on the “long tail” (e.g., advertising on low-volume websites). Another aspect of an embodiment of the invention includes methods and tools to identify and classify contextual relevancy of a page, on the fly, across a wide range of aggregated content. A client may thereby be provided with advertising appropriate to their interests. Such advertising may be, for example, in the form of advertising or other informational material to be delivered. For example, material such as a message (e.g., advertisement) may be presented within a web browser by insertion into a requested webpage, separately as a user leaves a web domain and immediately prior to retrieval and/or display of a requested webpage, delivered to a television screen using, e.g., a settop box, etc.

Another aspect of an embodiment of the invention may address the collection, storage, standardization and distribution of information about user activity including, for example, websites, web pages and content visited and/or downloaded, searches conducted, businesses called, television programming watched, etc. Thus, methods, systems and tools may be provided to identify and consolidate client information from one or more ISPs, switched networks elements (e.g., set top boxes), and other sources to provide ubiquitous services to plural clients. An appropriate set of rules, each defining particular target audiences for specific content such as advertising, may be applied to the behavioral information to match a client to the specific content. The sets of rules defining the characteristics of various target audiences may be publicly available or held private, accessible only with appropriate permission and/or license. Each service provider may be assigned an identifier as may be each end user. The service provider identification may be used to designate the source of behavioral information about an end user and, according to an appropriate arrangement, any credit attributable to the source.

According to another aspect of the invention, a method of providing targeted content to users through client devices connected to a network through service providers includes having a plurality of service providers, each enabling the monitoring of network activities of client devices connected to a network through such service providers. Information derived from the network activities is collected and rules are applied to the information to identify a user to receive the targeted content. The targeted content is thereupon provided to a client device associated with the identified user.

### BRIEF DESCRIPTION OF THE DRAWINGS

FIG. 1 is a schematic illustration of an example data network.

FIG. 2 is a schematic illustration of an example data flow for acquiring contextual information of a client.

FIG. 3 is a flow chart describing a method of acquiring contextual information of a client.

FIG. 4 is a schematic illustration of an exemplary computing device.

FIG. 5 is a schematic illustration depicting further aspects of a targeted content delivery approach.

FIG. 6 is an illustration of example content that may be varied in response to contextual information obtained from a client.

FIG. 7A is a flow chart describing an example where client browsing activity may be used to direct television advertising.

FIG. 7B is a schematic illustration of an example system for managing the delivery of video or television content.

FIGS. 8-9 are flow charts illustrating an example where search information is varied responsive to contextual information received from the client.

FIG. 10 is a schematic illustration of the data flows associated with an example content coordinator.

FIG. 11 is a schematic illustration of a content coordinator selecting content.

FIGS. 12A and 12B illustrate example weighting functions.

FIG. 13 illustrates several example scenarios describing how a channel may be selected, created, modified and shared with another party via a media planning tool.

FIGS. 14-15 illustrate example tools that may be used to select, create, or modify a channel.

FIGS. 16A and 16B are flow charts illustrating example methods of managing channel access.

FIG. 17 is a flow chart illustrating an example routine that may be performed to assess whether a channel is matched to a client.

FIG. 18 is a flow chart illustrating an example routine that may be performed to identify which channel of a plurality of channels may be selected.

FIG. 19 is a flow chart illustrating an example routine that may be used to simulate the performance of a campaign.

FIG. 20 is a flow chart describing a client opt-in/opt-out approach.

FIGS. 21 and 22 illustrate example menus that may be presented to a client user.

### DETAILED DESCRIPTION

The present disclosure is directed to systems and methods for selecting and delivering targeted content over a network, such as the Internet. The targeted content typically is delivered to an end user of a client device, such as a computer user browsing the internet with Microsoft Internet Explorer or the like. Client-specific content is selected and delivered based on behavioral information relating to the network activity of the client. For example, behavioral information may include web pages/sites visited, contextual information for a specific visited page (e.g. page keywords or other page characteristics), terms entered in search engines, frequency of site visits, etc.

In some disclosed examples, an Internet Service Provider (ISP) causes the client activity to be monitored, through a variety of mechanisms, so as to facilitate acquisition of behavioral information. One mechanism involves an ISP appending a tag or script to a requested web page. When the page is displayed by the client browser, an executable reads keywords or other contextual information from the displayed page. Contextual information for multiple pages may be recorded and collected over time to provide a behavioral depiction of client network activity.

The behavioral information may be reported out (e.g., over the Internet) and received by a coordinator or moderator entity, which then selects content based on the behavioral information. For example, the behavioral information may be received at a remote advertising server. Based on the behavioral information, the advertising server would select appropriate targeted advertising content for delivery to the client. Advertisements are but one type of targeted content that may be provided; many other examples are discussed herein. Targeted content may also be incorporated into video delivered to a client. In particular, behavioral-dependent content may be delivered via cable/satellite television, IPTV, web-delivered video (e.g., YouTube), etc.

The present disclosure also describes systems and methods for managing the delivery of targeted content. In a series of examples, a media planning tool is described which can be used to enhance the ability to correlate client behavior with desired targeted content.

The description also addresses privacy considerations, and provides numerous examples whereby users of client devices can “opt-in,” “opt-out” or otherwise control their participation in targeted delivery systems.

Still further, the description addresses use of the described infrastructure to manage client payments and client identity issues. In particular, as the ISP takes a more active role in monitoring the substantive activity of the client, the ISP may be employed to facilitate electronic transactions.

System Topology Overview

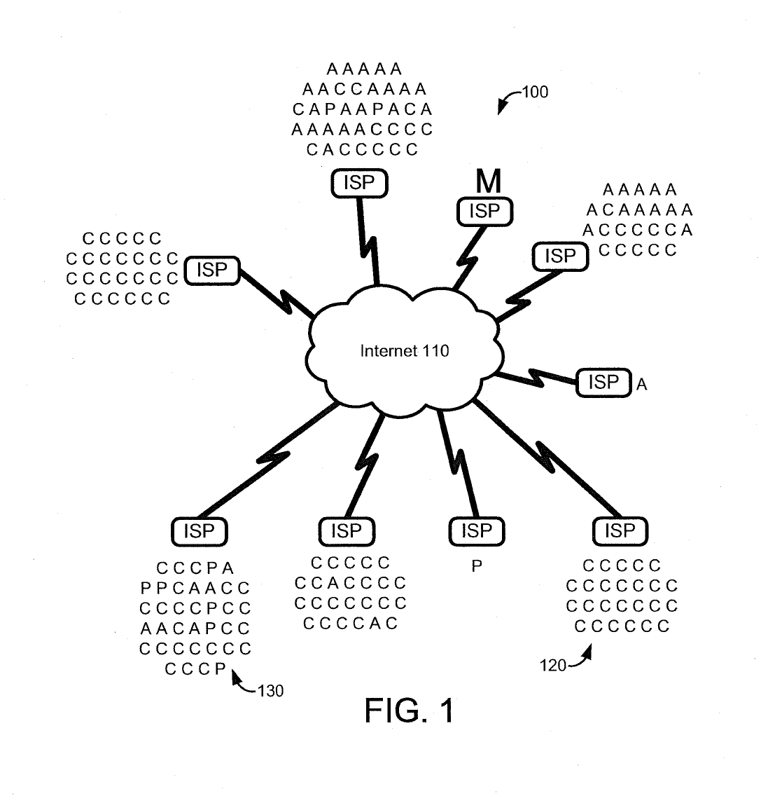

FIG. 1 provides a schematic illustration of an example network 100 as may be used to facilitate at least some of the various approaches described herein. Network 100 can be configured to enable at least two or more parties including clients (C), advertisers (A), publishers (P), and moderators (M) to communicate with each other. Clients (C) may include human users that can send or receive information via a client device such as a desktop computer, notebook computer, laptop computer, handheld computer, mobile telephone, personal digital assistant (PDA), television and/or radio, among other suitable devices. Advertisers (A) may include, but are not limited to businesses, individuals, and/or organizations that may be seeking to promote particular information, products, services, etc. Publishers (P) may include parties that provide content to clients, which may include websites, web pages, video, audio, television, radio, etc.

The present discussion includes only a limited number of entity types (client, advertisers, etc.) for purposes of clarity and illustration. It should be understood, however, that a variety of other entities can participate in the described examples. Generally, the entities involved will be (1) sources of targeted content, (2) recipients of targeted content, and/or (3) involved in the acquisition, selection and delivery of targeted content. Advertisers A typically fall into the first category; clients C fall in the second category; and the ISPs, moderator M and publishers P typically fall in the third. Other entities may be involved, however, and a given entity may fulfill more than one role.

FIG. 1 illustrates but a few of the nearly limitless topologies that can be employed. The clients, advertisers, publishers, and moderators can interact or communicate with each other by accessing the Internet 110 via an internet service provider (ISP). Further, an ISP may provide television, telephone, wireless, or other media content service to the client. Note that an ISP may also provide service to one or more advertisers, clients, and/or publishers, etc.

As illustrated generally at 120, a plurality of clients can send information to or receive information from the Internet via an ISP, thereby enabling communication with other clients, advertisers, or publishers, or moderators, for example, as illustrated generally at 130. Additionally, clients, publishers, and/or advertisers sharing an ISP may communicate via the same ISP. As illustrated by FIG. 1, an ISP may service only clients, only advertisers, only publishers, or combinations of clients, advertisers, and/or publishers.

The moderator (M), as described herein, can include any suitable party that moderates or coordinates the activities of one or more of the publisher, advertiser, and ISP to provide targeted content to a client. Under some conditions, the moderator entity may utilize what may be referred to as a content coordinator that can be configured to personalize many aspects of a user's web experience, from tailoring media content to personally-targeted advertising.

While the various parties have been described as advertisers, publishers, ISPs, clients, or moderators, it should be appreciated that these parties, under some conditions, may fulfill multiple roles. For example, under some conditions, an advertiser may also be a client, a publisher or an ISP; an ISP may be an advertiser; or a moderator may be an ISP, etc. As will be described herein, some of these parties may interact with a moderator to enable the delivery of content tailored to a particular user based on their behavior and/or context in which they interact with the network.

Throughout the present description, some of the following approaches may be described with reference to advertising content; however, it should be appreciated that any suitable content may be utilized. For example, any suitable media content, whether it includes images, text, video, audio, hyperlinks, hypertext (e.g. HTML), advertisements, non-advertisements, etc., may be varied responsive to a particular client's behavioral and/or contextual information, on a client by client basis.

Acquisition of Contextual/Behavioral Information

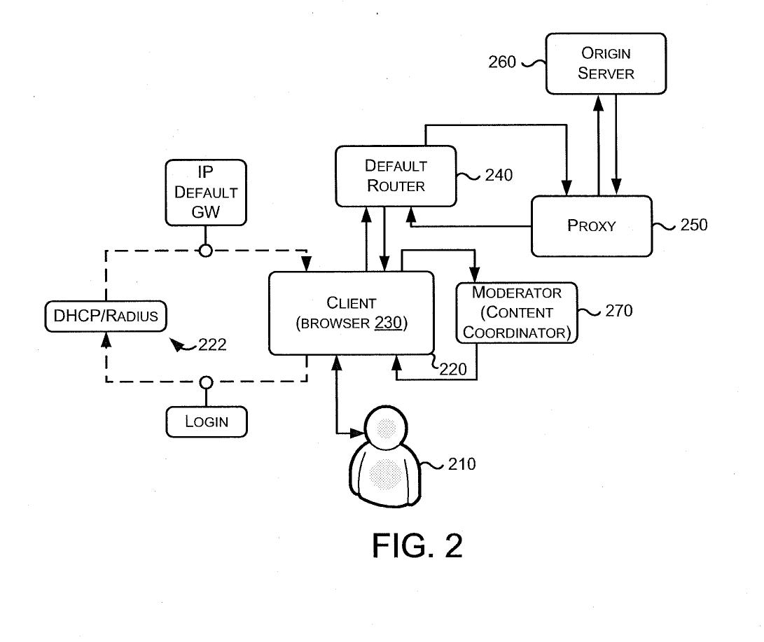

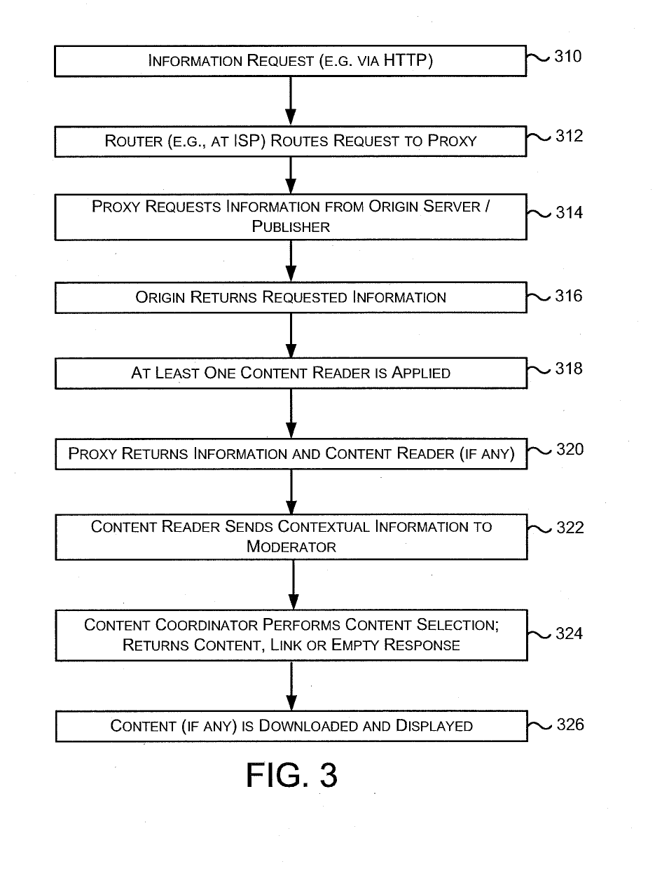

Referring to FIGS. 2-4, an approach will be described whereby a context reader retrieves contextual information relating to a client's interaction with the network. In particular, FIGS. 2 and 3 provide a non-limiting example describing how information associated with the behavior and/or context of a particular client may be acquired and used to provide tailored content to the client. Specifically, FIG. 2 provides a schematic illustration of an example data flow explaining how a client's contextual information may be acquired, while FIG. 3 illustrates a corresponding flow chart describing a method of acquiring the client's contextual information via the data flow of FIG. 2.

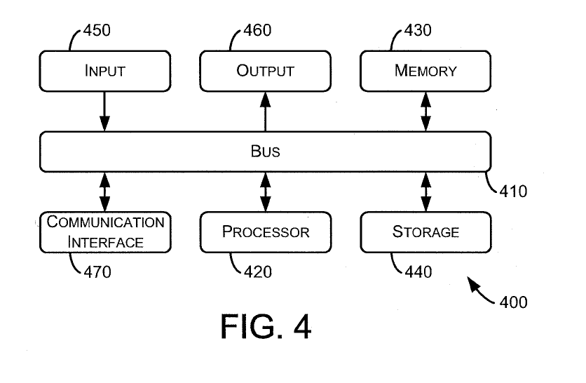

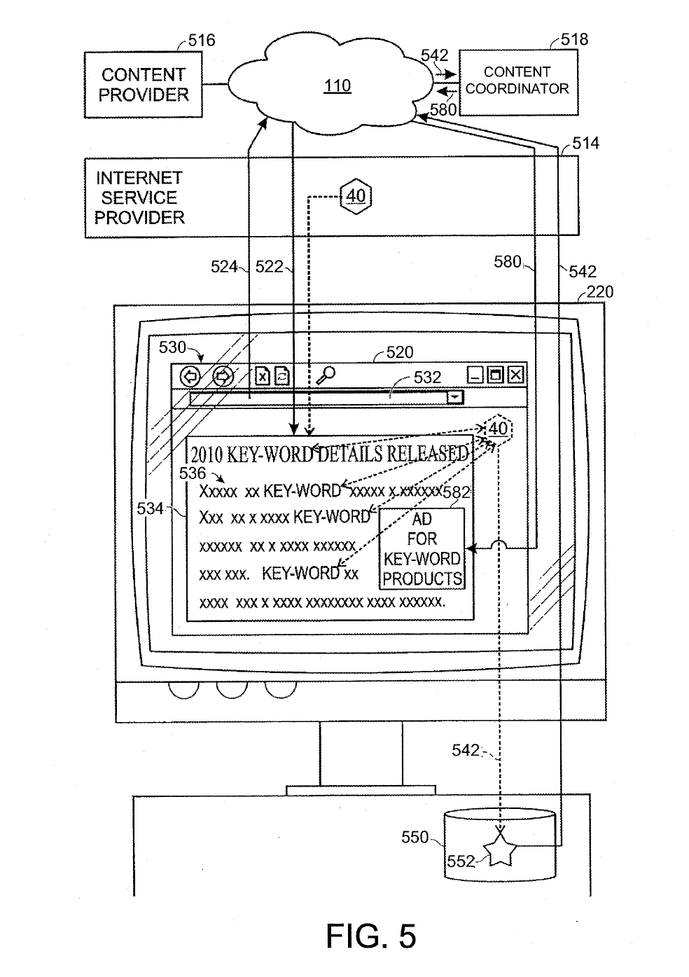

User 210 can access the Internet via a client device 220, which may include a browser 230. A more detailed description of client 220 will be provided below with reference to FIGS. 4 and 5. As one example, user 210 may seek to perform a selection, action, or request via client 220 and/or browser 230. For example, user 210 may request additional information by selecting a hyperlink, entering a web address, browsing web pages, changing a video or audio channel, etc. Client 220 may utilize a dynamic host configuration protocol (DHCP) 222 to request and obtain an internet protocol (IP) address, for example, upon login to the network by the client user. For example, the ISP associated with the client may utilize the DHCP to assign an IP address to the client. The IP address may be periodically refreshed, for example, upon login or at other suitable interval. Alternatively, the client may be assigned a static IP address that does not change. At 310, browser 230 may transmit a request for the information via an HTTP or other suitable protocol by way of the ISP. As one example, the browser makes an HTTP request for a particular web page on a prescribed port (e.g. port 80 or other suitable port). However, it should be appreciated that other suitable modes of facilitating the request may be utilized.

A router 240, such as a default router or other suitable router associated with the ISP of client 220, forwards this request at 312 to a transparent squid proxy 250. Proxy 250 may be associated, for example, with the client's ISP or other ISP. Proxy 250 forwards the client's information request, which as one example includes a webpage request, at 314, to an origin server 260. As one example, origin server 260 may be associated with any suitable content provider including publishers, ISPs, advertisers, moderators, etc. In response to the request, server 260 may return the requested information (e.g. webpage) as indicated at 316.

Next, at 318, one or more context readers may be used to acquire contextual information of the client. Several examples applications of a context reader will be described.

As a first example approach, at 318, the proxy may modify information returned to the client to include a context reader. For example, the proxy may append the context reader to the information returned to the client. A JavaScript tag may be appended to the end of the HTTP body, for example. Note that in at least one example, the tag can be appended outside the body of the HTML so that the content is not modified, while the browser is able to interpret and execute the tag. However, it should be appreciated that the proxy may make different modifications as desired, depending on the information requested. Regardless of how the information is modified, the proxy may then return the modified information including the requested information and context reader to the browser via router 240 as indicated at 320.

As a second example approach, at 318, a context reader may be applied at the proxy without necessarily requiring modification of the information returned to the client. For example, the context reader at the ISP proxy can identify contextual information from the information requested by and returned to the client. As the ISP has access to substantially all of the information sent or retrieved by the client, any suitable contextual information relating to the client may be identified and provided to a content coordinator to enable the selection customized content for the client.

As a third example approach, at 318, a packet or network traffic sniffer may be used. In this application, the data stream flowing through the network (e.g. via the ISP) may be captured where the data may be processed to enable the context reader to identify contextual information on a per client basis. In this manner, contextual information of a particular client may be identified without requiring a modification of the information requested by the client or without necessarily requiring the use or existence of a proxy. For example, where there is no inline proxy, the network traffic sniffer can be used to capture data passing through the ISP so that it can be read by the context reader.

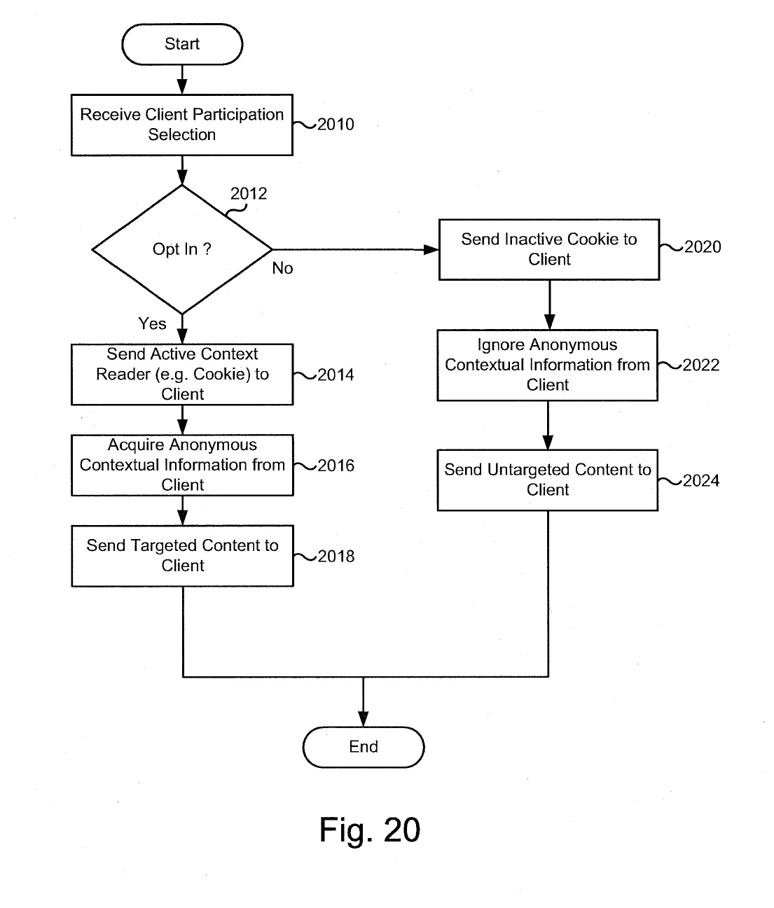

Note that one or more of the three context reader applications may be used in combination to acquire client information and that one or more context readers may be applied utilizing some or all of these approaches. As one example, a first context reader may be appended to the information returned to the client and a second context reader may be used in conjunction with a network traffic sniffer. Where the term context reader is used herein, it should be appreciated that the context reader may be applied using one or more of the context reader applications described above. Further, as will be described in greater detail with regards to FIGS. 20-22, a context reader may not be applied or may be disabled where the client opts-out of the content selection operation. In other words, the application of the context reader and/or reading of contextual and/or behavioral information of the client may be discontinued under some conditions, for example, upon request of the client.

Where the context reader is appended to the information returned to the client (e.g. via a tag) at 320, the context reader may be loaded into the browser upon receipt, along with the requested information. In some embodiments, different tags may be used to facilitate the selection and retrieval of custom content.

As a first example, a tag may be initially loaded whereby one or more additional tags may be requested from an external source (e.g. a server or the proxy). For example, a larger tag may be downloaded that performs failover testing and/or browser compatibility checks. Where testing or compatibility checks are utilized, additional tags may also be downloaded upon their successful completion. Note that JavaScript tags can be cached by the browser, so they may be downloaded, for example, only once per session. In this manner, the context reader can be loaded onto the client device via one or more tags.

As a second example, the context reader may be placed within the content retrieved by the client (e.g. via the publisher or ISP). For example, a tag may be placed on the web page by the web publisher that is configured to show particular advertisements, and/or select and retrieve content. In some examples, this tag may also be provided with a location where default content may be retrieved if no content is selected by the context reader.

Regardless of the particular type of tag that is applied to the client to achieve the retrieval of contextual information, the context reader may retrieve contextual information over one or more information requests by the client. The contextual information may be stored and/or processed by the content coordinator to create behavioral information. As described herein, behavioral information includes a historical account of the contextual information obtained from the client. For example, after at least one context reader has been applied, the client may perform multiple information requests over a period of time (e.g. browsing content such as web pages, etc.), whereby the ISP continues to facilitate the retrieval of the requested information. As the user browses the Internet, the context reader may be configured to return derivative information associated with the content (e.g. web pages) requested by client 220, whereby behavioral information may be developed.

As one approach, the context reader may be configured to perform a statistical and/or contextual analysis of the web page for a variety of contextual information. As described herein, contextual information may include one or more of a keyword, URL, search term, context reader based UID, meta tag, code, or other suitable information associated with the retrieved content. The contextual information may then be sent to a moderator 270 as indicated at 322. As one example, moderator 270 may include a server having a content coordinator as will be described in greater detail herein. Moderator 270 may be associated with a third party moderator, ISP, advertiser, publisher, or other suitable party. In at least some embodiments, the context reader can be configured to provide contextual information such as the most highly rated keywords or most prevalent keywords from the page, along with its URL. In some examples, this information may only be transmitted from the client in response to a request from moderator 270; however the context reader may continually provide contextual information, under at least some conditions.

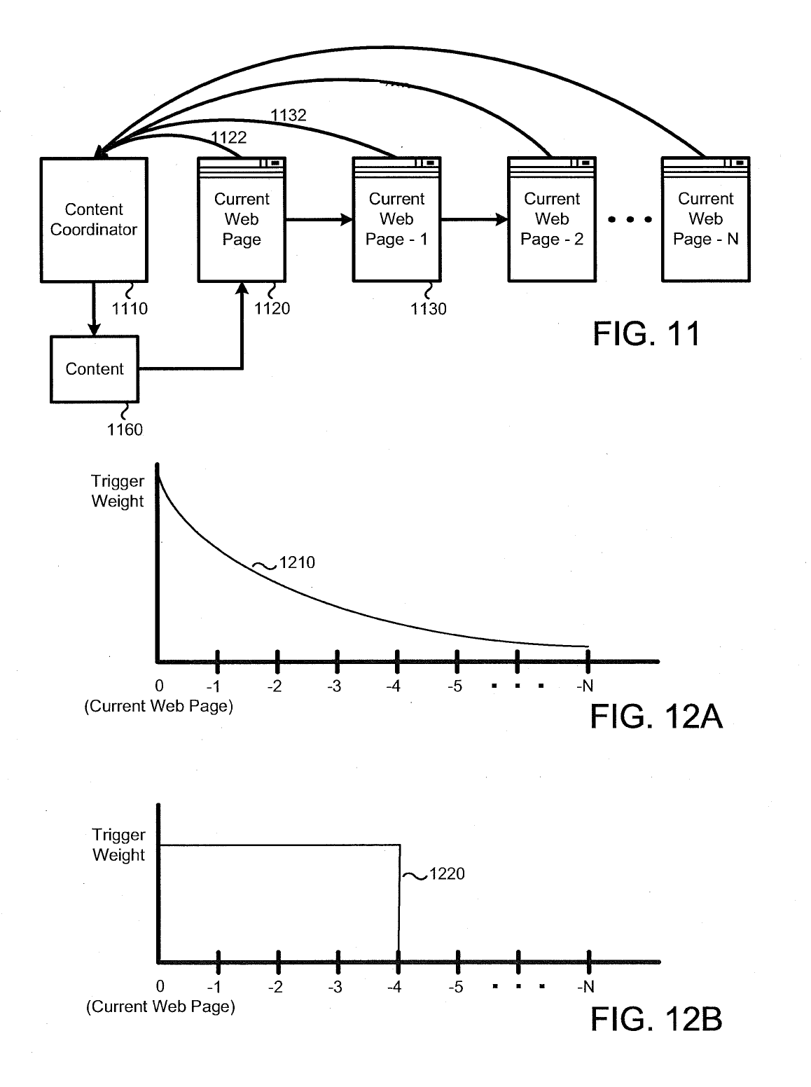

Moderator 270 can include a content coordinator that selects content to be delivered to the client responsive to the contextual information received from the client and/or stored behavioral information at 322. The selection operation performed by the content coordinator at 324 will be described in greater detail with reference to FIGS. 11-18. However, as one non-limiting example, moderator 270 may select the most relevant or a highly relevant advertisement for presentation to the client. For example, moderator 270 may consider the contextual and/or behavioral information, as well as a selection of advertising campaigns available, their revenue rates, and frequency cap information, etc. as selected by the advertiser and/or client's ISP. It should be appreciated that still other factors may be considered as will be described in greater detail herein.

Moderator 270, after selecting content, can return a link to the browser at 326 for directing the browser to the location where the selected content may be retrieved. For example, moderator 270 may send a link corresponding to the location of a third party server where the selected advertising content that may be retrieved by the browser. Alternatively, moderator 270 may return an empty or default response. In this case, default content may be provided to the browser or content may be retrieved from an alternative source such as the ISP, publisher or other advertiser. In yet another example, the content coordinator may provide the selected content directly to the browser as indicated by 326. For example, content, such as an advertisement may be transmitted to the client and/or browser where it may be displayed to the user. Where the browser receives the selected content, the content may be displayed as indicated by 320, and finally terminated. As one example, an advertisement may be retrieved from the link provided by moderator 270 and displayed within a webpage to be viewed by the user.

FIGS. 4 and 5 provide schematic illustrations describing, in greater detail, how contextual information may be retrieved from the client. FIG. 4 is an exemplary diagram of a computing device 400 having one or more of the components that may be employed at client 220, a service provider, a content coordinator, a content provider (e.g. advertiser, publisher, etc.), a moderator, or other suitable location to enable one or more of the functions described herein.

Device 400 may include, but is not limited to, a bus 410, a processor 420, a memory 430, a storage device 440, one or more input devices 450, one or more output devices 460, and a communication interface 470. Bus 410 may include one or more conductors that permit communication among the components of device 400. Processor 420 may include any suitable type of processor or microprocessor that interprets and executes instructions. Memory 430 may include a random access memory (RAM) or another type of dynamic storage device that stores information and instructions for execution by the processor 420. Memory 430 may also include a ROM device or other suitable type of static storage device that stores static information and instructions for use by the processor 420. Storage device 440 may include a magnetic and/or optical recording medium and its corresponding drive.

Input devices 450 may include one or more mechanisms that permit a user to input information to the client 220, such as a keyboard, a mouse, a touch screen, a pen, remote control, voice recognition device, optical recognition device, and/or biometric mechanism, etc. The output devices 460 may include one or more devices that output information to the user, including a display, a printer, a speaker, etc. The communication interface 470 may include any suitable transceiver-like device that enables client 220 to communicate with other devices and/or systems, such as to facilitate network communication with Internet 110 through one or more ISPs.

Various functions are described herein that may be carried out by device 400. Exemplary device 400 may perform these operations in response to processor 420 executing software instructions contained in a computer-readable medium, such as memory 430. A computer-readable medium may be defined as one or more memory/storage devices and/or carrier signals.

The software instructions may be read into memory 430 from another computer-readable medium, such as the data storage device 440, or from another device via the communication interface 470. As one example, hardware and/or software residing at a modem or set top box utilized by the client may be configured to facilitate the application of the context reader. Note that the context reader may be injected into the data flow where it may be loaded by the client device, may be applied at the modem or set top box, or may be facilitated by a network traffic sniffer located at the modem or set top box as described above with reference to FIG. 3. The software instructions contained in memory 430 can cause processor 420 to perform some of the processes described herein. Further, software instructions may include computer readable code that may be applied at the client or alternatively upstream of the client, for example, by the ISP or content provider via the ISP, or via the content coordinator. Again, a modem or set top box may be utilized to facilitate the application of the context reader. Further, hardwired circuitry may be used in place of or in combination with software instructions to implement processes consistent with the present disclosure. Thus, the present disclosure is not limited to any specific combination or location of hardware circuitry and software.

Referring now specifically to client 220, the device may be any suitable type of computing device capable of running browser software or other appropriate content access application, including a desktop computer, laptop, television, radio, handheld computer, mobile telephone, personal digital assistant, etc. Furthermore, the client may connect to a network from residential, commercial or other locations, such as businesses, hotels, schools, private residences, etc. From these locations, the client may be coupled using wired or wireless (Wi-Fi, Wi-Max, GPRS, EDGE, etc.) connections, or other types of connections, and may be connected individually or through local or private networks available at the connecting location. Furthermore, though the present disclosure discusses HTTP traffic in many examples, it will be appreciated that other types of protocols and traffic may be employed in connection with the targeted content delivery described herein. The present system and method may be employed for example, in connection with wireless devices employing WAP protocol.

FIG. 5 depicts further aspects of targeted content delivery according to the present description. As in the example of FIG. 3, client 220, content provider 516 and content coordinator 518 may be coupled to Internet 110, with the Internet access of client 220 being provided by an ISP 514. A content provider may include a publisher, an ISP, an advertiser, etc. Client 220 is shown running browser 230, which has user controllable browser controls 530 (e.g., navigational controls such as “forward,” “back,” “stop,” etc.) on address bar 532. An exemplary web page 534 is displayed by client 220, including a presentation/display of web page based content 536 which may be viewed by a user. As one example, the client may retrieve content such as web page 534 via a URL address submitted by a user via 524. The content may be returned to the client as indicated at 522, for example, from content provider 516.

Delivery of Targeted Content

As described above, it may be desirable, under some conditions, for content to be tailored specifically for the end user. Accordingly, the delivery of targeted content may include the use of a context reader indicated at 40 configured to obtain information relating to the data requested by and/or delivered to the client. Note that contextual or behavioral information may include the language utilized by the client, the geographic location of the client, and/or client preferences. According to one example, the context reader may be implemented as an instruction set that, alone or in combination with other components, causes an application to launch and operate on the data returned in response to end client HTTP requests or other client requests. Regardless of the particular code or other implementation, context reader 40 may be configured to obtain browsing information 542 based on the user's browsing behavior. As explained in more detail below, the browsing information is used to enable selection of tailored content that may be delivered to the client or computing device, such as for example, targeted advertising. The browsing information may include information about the content of web pages, which have been described herein as contextual and/or behavioral information. For example, for a given web page 534, the contextual information may include: (1) keywords found in web page content 536, such as the depicted “KEY-WORD”; (2) analysis and indexing of words or groupings of words on the web page; (3) frequency of keywords appearing on the page; (4) position of keywords appearing on the page; (5) URL or address of the web page; (6) relative size of the keywords; (7) visual images or symbols; (8) content requested by and/or delivered to the client (e.g. text, images, video, and/or audio, or any other data that may be used to select targeted content); (9) search terms; and others. The keywords and other analyzed data may be explicitly presented to the user (i.e., viewable), or hidden or embedded, as in the case of meta tags.

Context reader 40 is not limited to acquiring keyword or other content information pertaining to the currently viewed web page. Indeed, the browsing information may be collected so as to also include historical data pertaining to the browsing performed with device 220. According to one example, context reader 40 may send such historical browsing information to an ISP, content coordinator, moderator, or other party. Historical and/or current browser information may additionally or alternatively be tracked by the context reader. Such use of locally updated data may enable collection and use of browsing information for multiple web pages requested by the client. The context reader 40 and/or information agent may track other behavior information such as viewing behavior of on-demand video, audio, or game content. Accordingly, selection of targeted content may be based on historical data, including historical data pertaining to any of the keyword or other data referenced above, patterns of repetition associated with browsing behavior, user preferences, etc.

Beyond the particulars of the data in browsing information 542, or the manner in which it is collected, the browsing information may be reported out to content coordinator 518 via service provider 514 and/or Internet 110. Content coordinator 518 may be configured to receive browsing information 542 and use such browsing information to select, for example, content 580 (such as advertisement 582) to be returned to the browser that generated the browsing information. While advertising content is selected in this example, content coordinator 518 can be configured to select and provide other types of content, including specifically tailored versions of the requested content as modified based on observed browsing behavior or other contextual information associated with the client.

The context reader may set a cookie at 552 or otherwise store or update locally stored browsing information in memory or storage location 550. Note that storage location 550 may be included with the memory and/or data storage of the client device, for example, as illustrated in FIG. 4. In FIG. 5, the context reader causes browsing information 542 to be transmitted out to Internet 110 via service provider 514. The reporting of the browsing information may include, for example, transmission of cookie 552.

Alternatively, the actual context reading function may be performed at the service provider, moderator or other location, instead of on web pages displayed on the browser or via other content. Content including browser-requested data may be copied to a memory/storage location within the service provider (e.g., on a server). The copied data could then be analyzed to obtain browsing information, which would then be used by a content coordinator to perform selection and delivery of targeted content.

The approaches described above and illustrated by FIGS. 2-5 may be summarized in terms of a web based advertising scenario through the following four actions; however, it should be appreciated that other actions may be performed in addition to or as an alternative the following actions. First, a context reader is injected into a web page requested by the client. Next, information associated with the web page and/or subsequent web pages are analyzed. Next, an advertisement is selected based on the analysis of the web page information. Finally, the selected advertisement is retrieved by the client device and displayed to the user. Some or all of these actions may be repeated as the user continues to browse the Internet. In this way, information relating to the content requested by the client may be used to direct the delivery of advertisements, thereby enabling a more relevant and effective advertisement to be presented to the user. Since much or substantially all of the data sent or received by the client passes through the ISP, a broader view of client activity may be achieved, thereby facilitating a more informed content selection process.

Throughout the process described above with reference to FIGS. 2, 3, and 5, the ISP can facilitate the following activities: The ISP provides Internet access to the client device and/or browser to permit the client to download a context reader (e.g. JavaScript tag or other modified information), and enables communication between a content coordinator and the client. The ISP can ensure that the HTTP requests or other information requested by the client are redirected to a proxy (e.g. by port redirection on the default gateway, PAC browser reconfiguration, or other suitable method of redirection). In this way, an ISP may facilitate the acquisition of contextual information relating to a client to enable the selection and delivery of personalized content to the client.

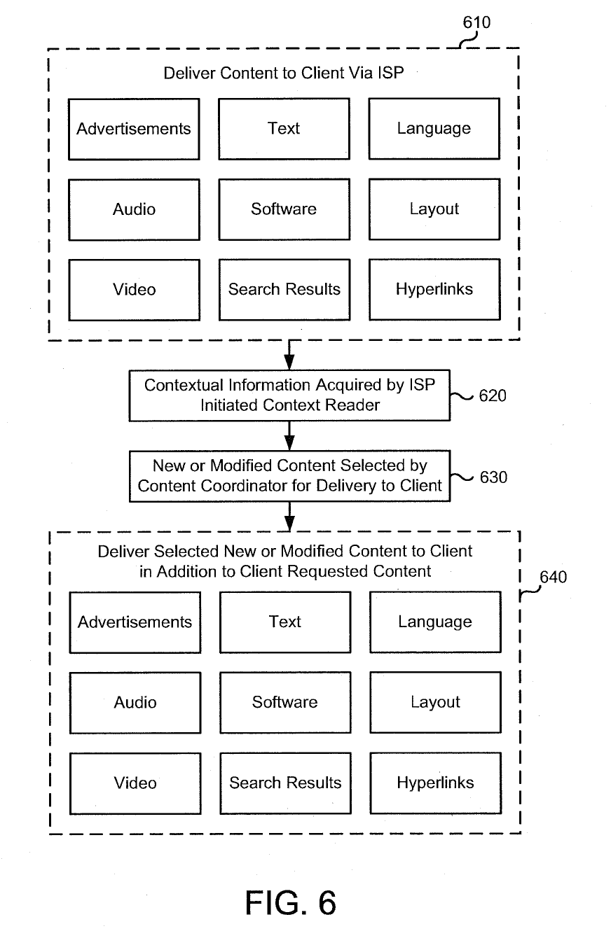

Once contextual and/or behavioral information relating to a particular client has been obtained, content may be selected and delivered to the client in response to the obtained information. FIG. 6 provides an illustration of some of the content that may be varied in response to contextual and/or behavioral information obtained from a particular client. For example, as indicated at 610, the content provided to the client via an ISP may include, but is not necessarily limited to one or more of the following: advertisements, written text, audio, video (e.g. Internet television, cable television, on-demand video, etc.), software applications (e.g. updates, modifications, added content, etc.), search results, language type (e.g. English, French, Japanese), layout (e.g. configuration or arrangement of the displayed content), hyperlinks (e.g. redirection to different web pages), among other content and combinations thereof.

At 620, the acquisition of contextual information associated with the content delivered to the client may be initiated, for example, by loading a context reader at the client and/or ISP as described above with reference to FIGS. 2-5. At 630, new or modified content may be selected by the content coordinator responsive to the contextual and/or behavioral information received from the context reader. Note that the content selected by the content coordinator may be varied independent of the originating content. As one example, contextual and/or behavioral information associated with one or more web pages retrieved by the client may be used to select video or audio content. As another example, contextual and/or behavioral information associated with video or audio content supplied to a client may be used to select written content and/or refine search results.

At 640, the selected content may be delivered to the client via the ISP. The new or modified content may also include, but is not necessarily limited to one or more of the following: advertisements, written text, audio, video, software applications, search results, language, layout, and hyperlinks, among others and combinations thereof. Note that video content may be accompanied by corresponding audio content and vice-versa.

As described herein, advertisements may include banner advertisements, bridge advertisements (e.g. temporally arranged between two sets of content delivered to the client), interstitial advertisements, floating advertisements, pop-up advertisements, video advertisements, and audio advertisements, among others and combinations thereof.

Targeted Content in Video Applications (IPTV, Cable Television, Etc.)

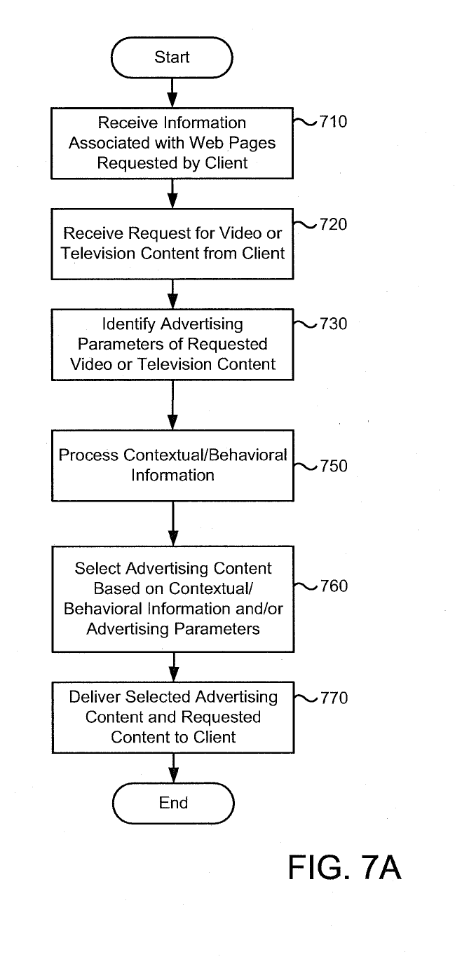

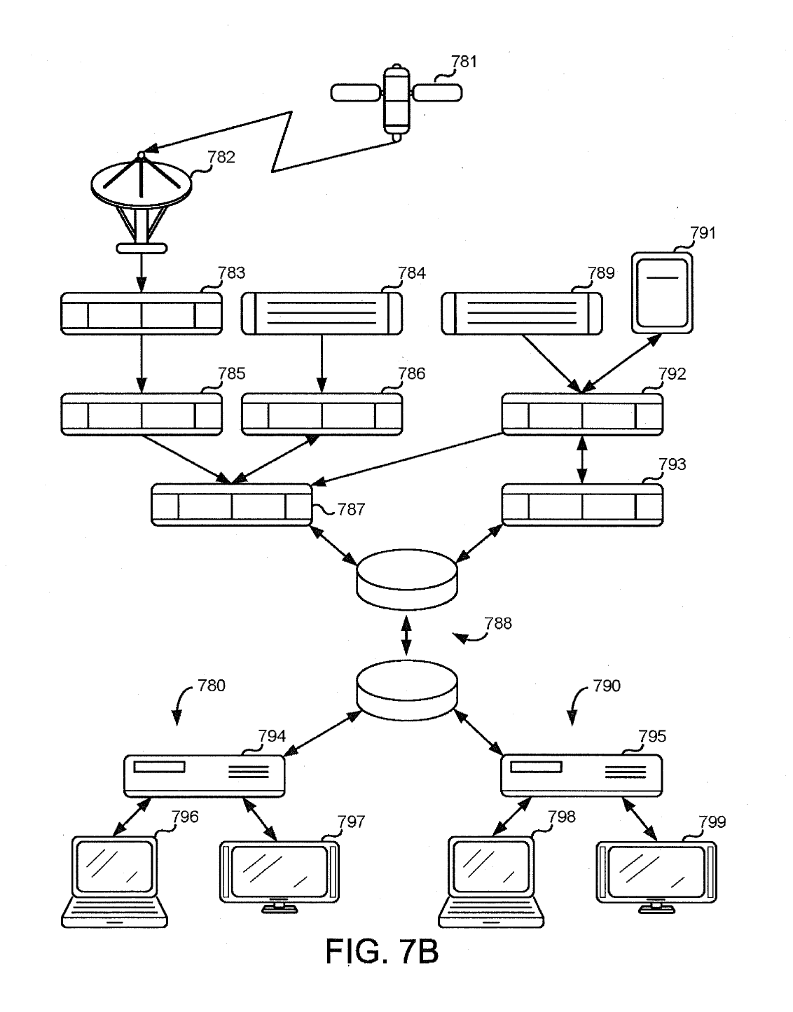

As one example application, a user may request video content that is to be delivered to their client device from a publisher via their respective ISP. For example, the user may be utilizing what may be referred to as Internet television, internet provider television (IPTV), streaming video, or web-delivered video. Responsive to this request, the client can be targeted with advertising content that was selected by the content coordinator based on past browsing behavior. For example, advertising content such as embedded advertisements may be swapped into predefined locations on the web page surrounding the video content. Additionally or alternatively, video advertisements can be included within the video stream. For example, video advertisements may be included at the beginning of the video content requested by the client, during commercial breaks (e.g. between two sections of video content), and/or at the conclusion of the requested video content. As one non-limiting example, these video advertisements may be between 5 seconds and 30 seconds in duration; however, other suitable durations are also possible. In this way, two or more clients of a plurality of clients may receive different advertising while viewing video via their ISP based at least partially on their past behavior as acquired by the context reader. Note that while the video content that is retrieved by the client during a viewing session may be considered by the content coordinator when selecting advertising content, it should be appreciated that the content coordinator is not necessarily required to utilize contextual and/or behavioral information associated with this video content since other contextual and/or behavioral information of the client may be available. A more specific application of the above approach will be described with reference to FIGS. 7A and 7B.

FIG. 7A is a flow chart illustrating an example where client browsing activity may be used to direct video or television (e.g. IPTV) advertising. At 710, the content coordinator receives contextual/behavioral information associated with web pages retrieved by the client. At 720, the client may request video or television content via the ISP. At 730, the request for content may be received by the content coordinator where advertising parameters relating to the requested video or television content may be identified. For example, it may be judged whether the requested content enables embedded advertisements and/or video advertisements as well as the duration and/or location where advertising may be placed.

At 750 and 760, contextual/behavioral information is processed in order to select the content that is to be delivered. This may include processing contextual/behavioral information in the video content that is requested, and/or that has been acquired from monitoring browsed web pages (e.g., at 710). Regardless of the source of the contextual/behavioral information, it is employed by the content coordinator to select appropriately from the available content (e.g., the closest matching advertisement). The selected advertising or other targeted content may then be delivered to the client at 770. For example, commercial advertisements may be inserted into predefined locations in the video or television content and/or embedded advertisements may be placed by the browser within a region surrounding the video or television content.

FIG. 7B illustrates an example system for facilitating the delivery of tailored television, video and/or web page content to a client. As one example, the system illustrated in FIG. 7B may be used to facilitate the content delivery approach of FIG. 7A as described above relating to IPTV, streaming video, or television content.

A client indicated generally at 780 may include a set top box 794 that enables a client user to browse internet web pages, view video and/or television content, for example, via computer 796 and/or television 797. For example, set top box 794 can enable a client user to receive IPTV and web content via a single ISP. While client 780 includes a separate computer and television to respectively receive web content and television content, it should be appreciated that this is one non-limiting example configuration. In alternative embodiments, IPTV and/or streaming video may be accessed via computer 796 or other suitable device and/or web browsing may be achieved via television 797.

A second client indicated generally at 790 may similarly include a set top box 795, a computer 798, and/or a television 799. Note that clients 780 and 790 may be located at the same household or residence, or may alternatively reside at different residences. For example, clients 780 and 790 may be located at a single residence, among different rooms, yet access the internet via a common ISP. Alternatively, clients 780 and 790 may be located at different residences and access the internet via the same ISP or different ISPs. In this example, clients 780 and 790 can receive web based content and/or IPTV or video content upon request.

IPTV or other suitable video content may be delivered to the clients via a content management system indicated at 787. As will be described, system 787 can receive IPTV or other video content from one or more sources. As one example, a content acquisition and video encoding server indicated at 783 can receive content from publishers, for example, via satellite 781 by receiver 782. Alternatively or additionally, content may be received via other suitable modes of transmission including cable or wireless, etc. The content acquired and encoded at 783 may be transmitted to a streaming server at 785, which may in turn pass the streaming IPTV or video content (e.g. video, audio, television, etc.) to a content management system indicated at 787. Additionally or alternatively, content (e.g. video, audio, television, etc.) stored at storage device 784 may be transmitted to an on-demand server indicated at 786 upon request from the content management system 787. As one non-limiting example, content management system 787 may request video content from video storage 784 via on-demand server 786. In this manner, a client may request IPTV or other video content which may include on-demand content via storage device 784 and/or streaming content via content acquisition server 783.

Web content may be delivered to the clients via an ISP proxy server 793, for example, as described above with reference to FIG. 2. While clients 780 and 790 browse websites, contextual and/or behavioral information may be acquired from the clients (e.g. via a context reader) and transmitted to a moderator server at 792. Note that this approach was described above with reference to FIGS. 2-5. Contextual information retrieved from the clients and/or ISP proxy server may be stored and/or retrieved from a behavioral information database 791, which can be associated with the moderator, for example. Note that contextual and/or behavioral information obtained from client 780 may be distinguished from contextual and/or behavioral information obtained from client 790, thereby enabling content to be tailored to the specific client.

Moderator server 792 can include a content coordinator that selects content to be delivered to each of the clients based on their respective contextual and/or behavioral information. Note that this contextual and/or behavioral information may include information received from the client via the ISP proxy server and may include historical (e.g. behavioral) information retrieved from the information database 791. The content coordinator may select customized content such as described above with reference to FIG. 6 and retrieve the selected content from a content server at 789. Server 789 may include advertising and/or customized content streaming servers. The content (e.g. advertisements) retrieved from server 789 can be transmitted to content management system 787 and/or ISP proxy server 793 depending on the type of content and end-use application.

For example, where video, audio, and/or television advertising content is to be inserted into IPTV or other video content, moderator 792 can transmit the content to the client via the content management system. Alternatively, this content may be provided to the client via the ISP proxy server. For example, where advertisements are to be provided to the client alongside the requested IPTV content, the ISP proxy server may be used. Regardless of the specific manner in which content is provided to the client, different content may be provided to each client based on their respective contextual and/or behavioral information acquired by the ISP. In this manner, contextual and/or behavioral information acquired from web browsing activity of a client may be used to select IPTV or other video advertising that may be provided to the client in addition to their requested content.

From the above, it will be appreciated that servicing the Internet and cable television/video needs of a user through a single ISP or alliance of ISPs affords many different opportunities to leverage contextual/behavioral information. A further example in this regard includes varying the content of a television commercial based on prior internet activity. More particularly, search engine requests may be employed to control subsequent content of television commercials. Were a user to enter “Mercedes 5500” (a brand/model of automobile) into a search engine (or satisfy some other set of conditions in the course of interacting with the Internet), for example, that could be used to trigger a Mercedes 5500 television commercial appearing during a commercial break in cable/satellite programming being viewed by the user. In some cases, this would be facilitated by a common ISP providing Internet and cable/satellite access to the user; however the same result could be achieved through concerted activity of multiple ISPs. Many further examples are possible, with video/cable activity triggering contextual/behavioral information that affects non-video web content, and vice versa.

In some cases, different types of content are delivered to end users at varying service levels. For example, an ISP may allocate or reserve bandwidth according to a priority scheme, in which the fastest connection speeds are reserved for specific data types, uses, customers, etc. The targeted content systems and methods of the present description may be configured to take advantage of these tiered-bandwidth environments.

In one example, certain contextual/behavioral triggers can be used to cause delivery of content (such as advertising, HDTV-quality web-delivered video, etc.) that is not subject to the bandwidth limitations imposed on other traffic. An ISP might, for example, set aside some portion of its high-bandwidth connections and make those available to advertisers who are willing to pay a premium. An advertiser or other entity could then specify, for example, that when a user's behavior is characterized by parameters X, Y and Z, that the advertiser would be willing to pay a premium in order to have desired high-quality advertising content (perhaps higher in quality than other content provided by the same advertiser) reach the user through a higher-speed ISP connection.

Exemplary Search Applications

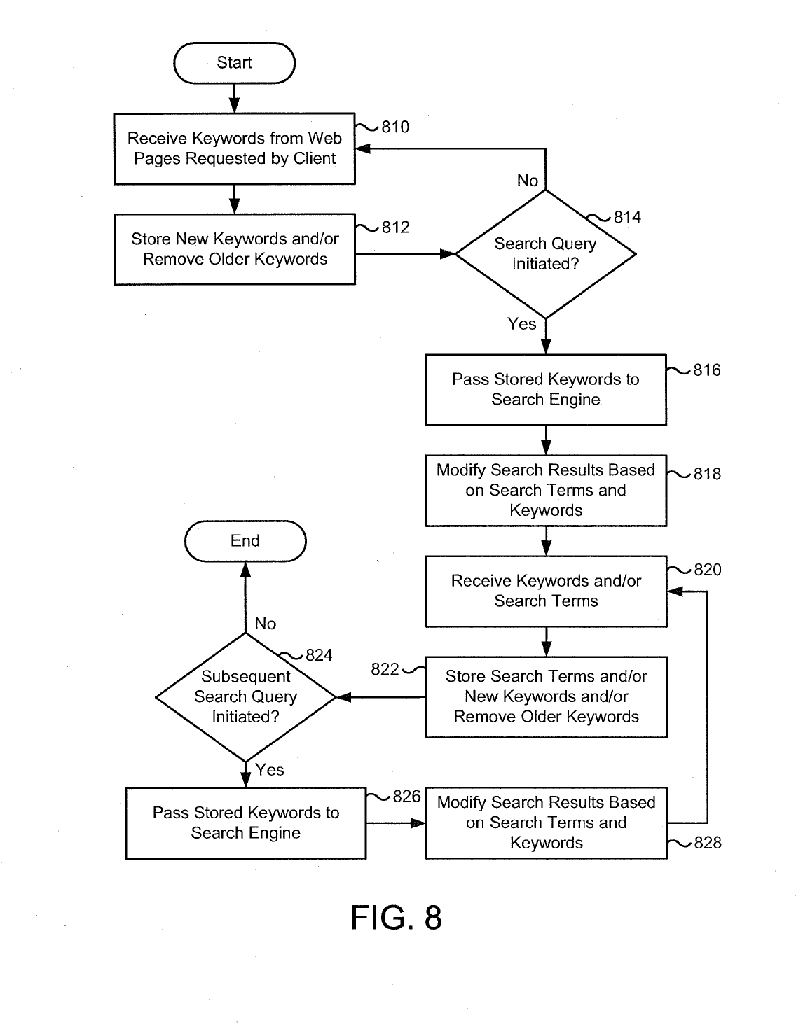

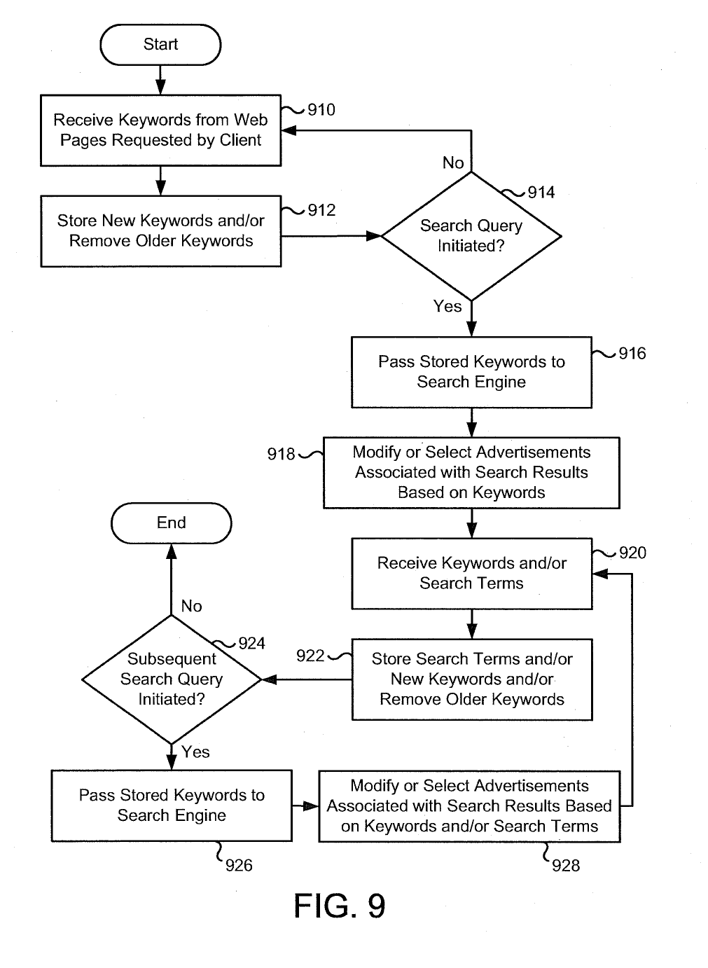

Referring now to FIGS. 8 and 9, in another example application, the acquisition of contextual information relating to a particular user can enable the enhancement of applications relating to the field of search. As one example, the use of contextual and/or behavioral information including keywords associated with web pages retrieved by the client can be passed by the context reader to a search engine. In this way, the relevancy of the search results returned to the user may be improved, and/or text advertisements provided, for example, via Google AdSense, Yahoo Sponsored Search, or others may be enhanced.

As the context reader collects keywords from each web page visited by the user based on the frequency of the keyword, keyword type, keyword location, or other factor, some of the keywords associated with a set of web pages browsed by the user (e.g. the last ten web pages retrieved) may be stored and continually updated in a user profile. The user profile may be stored in memory at the client device, ISP, content coordinator, moderator, advertiser, search engine, or other suitable location. The top correlating keywords (or other condition) from the collected of keywords may be referred to as context keywords, as they are indicative of the general context of the recent web pages browsed by the user.

For example, where a user initiates a search query after browsing at least some web pages, context keywords can be passed to the search engine in order to drive more relevant search results and/or text advertisements placed on the search results page. For example, the search results returned to the user may be varied by the search engine responsive to the context keywords supplied by the context reader, wherein the context keywords can be associated with a historical set of web pages viewed by the user prior to the search query.

With regards to text or banner advertisements that are provided to the browser responsive to the user's search query, such as may be provided by Google AdSense, the relevancy of the text advertisements may be improved by considering not only the context keywords associated with the present web page, but the historical set of web pages retrieved by the client. For example, the context keywords associated with past web pages can be injected into the Google AdSense tag or other search engine tag so that these keywords can be used by the search engine as an additional targeting recommendation. In other words, where advertisements are provided responsive to a user initiated search query, advertisements may be varied responsive to not only the search query, but additionally or alternatively to context keywords associated with prior web pages retrieved by the client.

Note that the historical set of context keywords can be updated continually or can be reset after a search is initiated by the user. For example, if a user returns to the search engine to refine a search query after a previous search has been initiated, the stored context keywords can updated to include the previous search terms and/or context keywords associated with web pages retrieved between the first search query and a second subsequent search query to enable more relevant search results.

FIGS. 8 and 9 are flow charts illustrating how search results may be modified responsive to the client's contextual and/or behavioral information and advertisements provided in conjunction with the search query, respectively.

Referring to FIG. 8, keywords may be received by the content coordinator from web pages requested by the client, for example, via the context reader at 810. At 812, the keywords may be stored (e.g. at the client, ISP, content coordinator, publisher, etc.) and/or some of the older keywords may be removed based on the particular operating parameters applied by the advertiser. In other words, the stored keywords may be updated based on a prescribed method. At 814, it may be judged whether the client has initiated a search query. For example, the client may utilize a web based search engine to facilitate searching. If the answer is no, the content coordinator may continue to receive keywords associated with the web pages retrieved by the client at 810.

Alternatively, if the answer at 814 is yes, then the stored keywords and/or channel recommendations may be passed to the search engine at 816 to enable the search results returned to the client to be modified based on the keywords, channel recommendations, and/or search terms submitted by the client at 818. Keywords or other contextual and/or behavioral information may be passed to the search engine under certain conditions, while channel recommendations may be passed to the search engine under other conditions. For example, where privacy is a concern, the channel recommendations may be used instead of specific contextual and/or behavioral information such as keywords. In this manner, the privacy of the specific client may be protected. Where channel recommendations or other targeting recommendations are passed to the search engine, the content coordinator may be configured to select the particular recommendation based on the contextual and/or behavioral information received from the context reader. In this way, information that is passed to third parties may be amended to be free of or include less specific contextual and/or behavioral information of a client. At 820, the search terms submitted by the client may be received as well as additional keywords, or channel recommendations relating to web pages visited by the user after the search query was initiated. At 822, the search terms and/or keywords may be stored and/or older keywords or search terms may be removed. In other words, the stored keywords and search terms may be updated.

At 824, it may be judged whether a subsequent search query has been initiated by the client. If the answer at 824 is no, the routine may end. Alternatively, if the answer is yes, the stored keywords and/or search terms may be passed to the search engine at 826 to facilitate the modification of the search results returned to the client based on the new search terms, stored search terms, stored keywords, and/or channel recommendations at 828. The routine may return to 820 where subsequent keywords and/or search terms are stored. In this manner, search results may be modified and/or improved by utilizing a historical view of the web pages retrieved by the client and/or search terms utilized by the client during a search query. Note that in one example, this method may be applied across two or more different search engines to provide even greater improvements in the relevancy and effectiveness of the search query.

Referring to FIG. 9, keywords may be received by the content coordinator from web pages requested by the client, for example, via the context reader at 910. At 912, the keywords may be stored (e.g. at the client, ISP, content coordinator, publisher, etc.) and/or some of the older keywords may be removed based on the particular operating parameters applied by the advertiser. At 914, it may be judged whether the client has initiated a search query. For example, the client may utilize a web based search engine to facilitate searching. If the answer is no, the content coordinator may continue to receive keywords associated with the web pages retrieved by the client at 910.

Alternatively, if the answer at 914 is yes, then the stored keywords and/or channel recommendations may be passed to the search engine at 916 to enable the search engine to modify or select advertisements associated with the search results based on the keywords and/or search terms submitted by the client at 918. At 920, the search terms submitted by the client may be received as well as additional keywords relating to web pages retrieved by the client after the search query was initiated. At 922, the search terms and/or keywords may be stored and/or older keywords or search terms may be removed. In other words, the stored keywords and search terms may be updated.

At 924, it may be judged whether a subsequent search query has been initiated by the client. If the answer at 924 is no, the routine may end. Alternatively, if the answer is yes, the stored keywords and/or search terms may be passed to the search engine at 926 to facilitate the modification or selection of advertisements returned to the client based on the new search terms, stored search terms, stored keywords, and/or channel recommendations at 928. The routine may return to 920 where subsequent keywords and/or search terms are stored. In this manner, advertisements associated with search results may be modified and/or improved by utilizing a historical view of the web pages retrieved by the client and/or search terms utilized by the client during a search query. Note that this method may be applied across two or more different search engines to provide even greater improvements in the relevancy and effectiveness of the advertising delivered to the client.

It should be appreciated that the approaches described above with reference to FIGS. 8 and 9 may be applied alone or together to facilitate improved search results and enhanced advertising. Furthermore, it should be noted that search functionality may be combined with delivery of targeted content in video applications. For example, a search engine query for a particular brand and model automobile could trigger delivery of an advertisement through the user's cable television service. The targeted advertisement could be delivered, for example, during an upcoming commercial break in the television program.

Managing Delivery of Targeted Content—Media Planning Tool

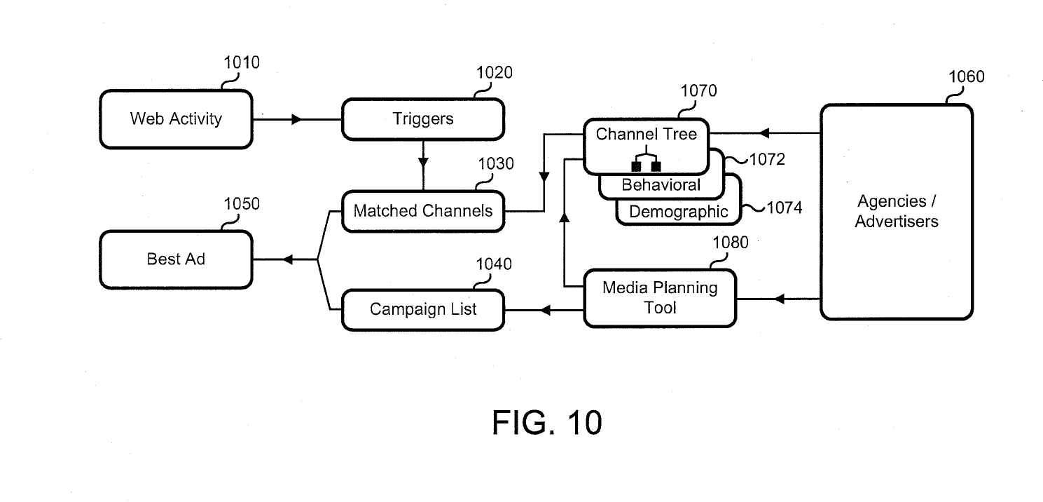

As described above, a content coordinator may be used to identify and/or select content that may be delivered to a client device based on information acquired from the client. FIG. 10 provides a schematic illustration of the data flows associated with an example content coordinator. Contextual and/or behavioral information relating to the activity of a particular client (e.g. web activity) may be received from a user's client device as indicated at 1010. The contextual and/or behavioral information received by the content coordinator may be sufficient to trigger the activation of one or more channels, which may cause content to be delivered to the client. In this way, contextual and/or behavioral information may be continually updated as received from the client in response to client activity.

The selection of content may be performed by matching one or more channels to the client where the contextual and/or behavioral information is sufficient to activate one or more triggers associated with the channels. As one non-limiting example, a set of contextual and/or behavioral information associated with a past set of web pages (e.g. the past 10 web pages) retrieved by the client may be compared in parallel to a group of channels to identify content that may be delivered to the client. A channel as described herein may include a set of weighted triggers (e.g. having a positive or negative value) and logical operators, which may be embodied in an XML-based “Channel Definition Markup Language” (CDML), for example.

As will be described in greater detail, the universe of possible triggers may be mapped onto a “channel tree” which represents the various categories or channels of advertisements that may be utilized by advertisers when targeting certain types of clients. Where a trigger is activated by the contextual and/or behavioral information provided from a client, the channel may direct particular content associated with the channel to the client. These channels may be contextual in that they match the immediate content of the web activity. By recording channel matches over time, the system can build up both session behavior and longer-term history for a particular client or set of clients. Further, by cross-referencing with third party data, providers such as Nielsen, Comscore via Media Metrixs, online surveys, etc., the approaches described herein may also provide demographic profiles and groups. The contextual and/or behavioral information of one or more clients may be combined with a range of available campaigns and their corresponding rates and performance to provide the highest-yielding advertisement to the client user based on their behavior or who they are (e.g. demographic), what they have done (e.g. session and history), and/or where they are now (e.g. contextual).

FIG. 11 provides a schematic illustration explaining how the content coordinator selects content. As one example, content coordinator 1110 can utilize contextual information associated with the present or current web page to activate triggers as indicated by 1122. The content coordinator may utilize contextual and/or behavioral information associated with a previous web page such as at 1130 as indicated by 1132. Similarly, contextual and/or behavioral information associated with even older or previous web pages may be considered by the content coordinator for selecting content to be delivered to the current web page.

Further, in some embodiments, the content coordinator may adjust the weighting of the contextual and/or behavioral information based on the temporal location of their respective web page. FIGS. 12A and 12B illustrate non-limiting examples of how the weighting of contextual and/or behavioral information may be varied in response to the historical context of their originating web page. For example, FIG. 12A illustrates how contextual and/or behavioral information associated with more recent web pages may be more influential to the content coordinator as compared to contextual and/or behavioral information associated with less recent web pages. In other words, contextual and/or behavioral information such as keywords or other information associated with the webpage more recently received by the client may have greater effect on the decision process than the keywords associated with a prior web page. As illustrated by FIG. 12B, contextual and/or behavioral information associated with two or more web pages may be given equal weighting up until a particular threshold (e.g. the 3 or 4 previous web page views). For example, contextual and/or behavioral information associated with the current web page and the three prior web pages may be utilized by the content coordinator while triggers associated with web pages occurring even earlier may be omitted or provide less influence toward the selection of content. While FIGS. 12A and 12B provide example weighting functions 1210 and 1220 respectively, it should be appreciated that any suitable function may be used to control the selection of content. Further still, these weighting functions may be adapted or optimized based on parameters set by the advertiser or content provider to further enhance the tailored content that is delivered to the client.

Returning to FIG. 10, advertisers 1060 may select and/or create channels via media planning tool 1080 including triggers that can be activated by contextual and/or behavioral information received from the client. The media planning tool can be used to enable one or more advertisers, ISPs, publishers, etc. to control the content coordinator for a particular campaign. Note that the term advertiser as used herein, may include publishers, advertisers, ISPs, content providers, moderators, etc.

As one example, channels may be selected from a public forum via the media planning tool and/or channels may be shared among two or more advertisers. In some embodiments, the public forum as facilitated by the media planning tool may be used to enable advertisers, publishers, ISPs, moderators, etc. to share ratings and discussions regarding content targeting and channel configuration or construction. Alternatively or additionally, channels may be selected from a private forum on a per fee basis via the media planning tool. In some embodiments, private channels may only be used where a fee is paid to the exchange for their use. Further, channels whether public or private may be modified by the advertiser to suit their particular needs. Further still, channels may be created by the advertiser and may be used in a public forum or privately as desired by the advertiser.

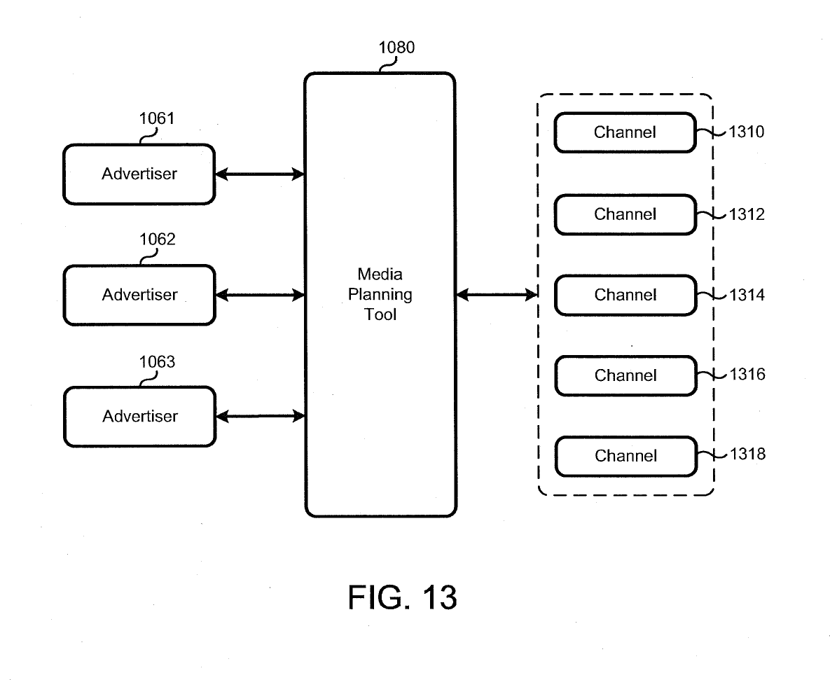

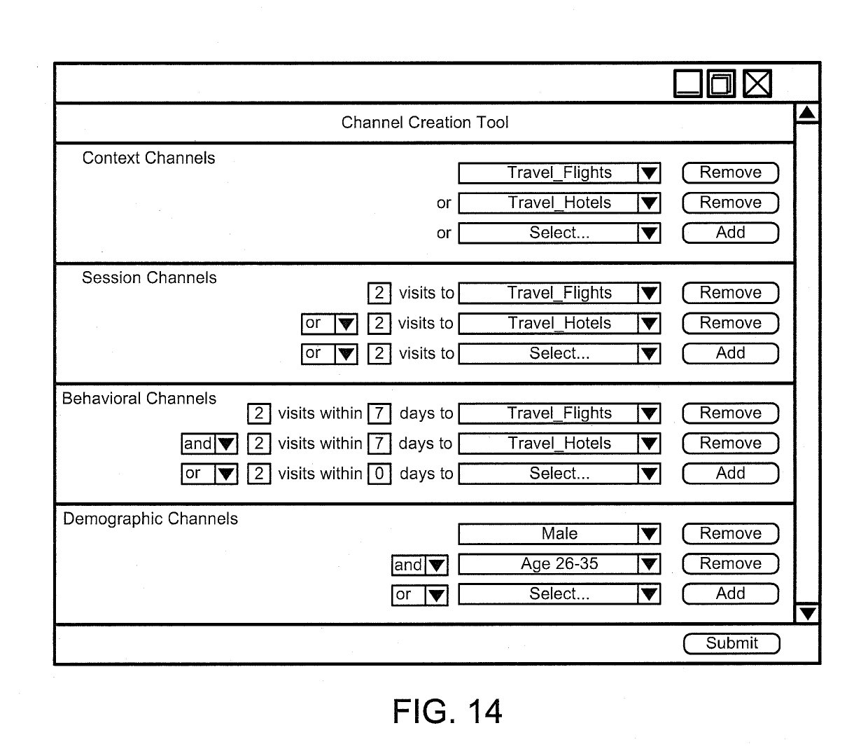

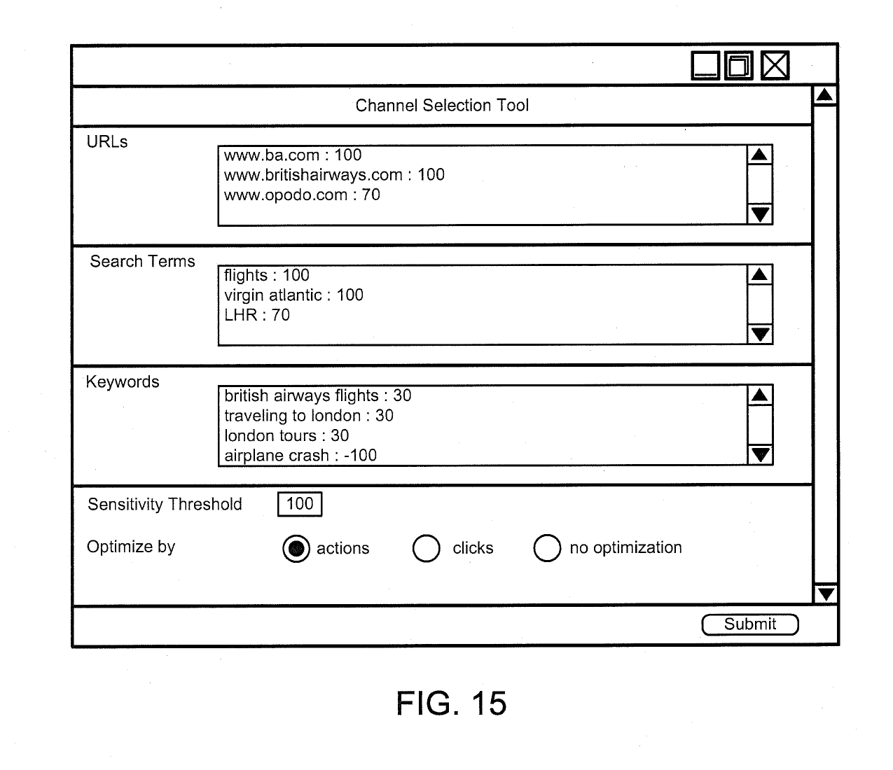

FIG. 13 illustrates several example scenarios for explaining how an advertiser may select, create, modify and share a channel via the media planning tool. As illustrated by FIG. 13, advertisers 1061, 1062, 1063, etc. may access and/or share channels 1310, 1312, 1314, 1316, and 1318 via media planning tool 1080. In this particular scenario, channel 1310 includes a public channel that may be shared between two or more advertisers via a public forum as facilitated by the media planning tool. For example, advertiser 1061 may have created channel 1310 with the media planning tool as will be described in greater detail with reference to FIGS. 14 and 15, whereby the channel was shared with advertiser 1062 and/or 1063 as a public channel. In other words, Advertisers 1062 and 1063 may be able to access and/or use channel 1310 as created by advertiser 1061 or may alternatively modify channel 1310 to suit their particular needs.

For example, advertiser 1062 can modify channel 1310 to create channel 1312. Further, advertiser 1062 may choose to set channel 1312 as either a private or public channel. For example, where channel 1312 has been set as a private channel, advertiser 1062 may limit access to channel 1312 to specific advertisers that they select. As one example, advertiser 1062 may sell or license channel 1312 to another advertiser, such as advertiser 1063, while withholding access of channel 1312 from advertiser 1061.

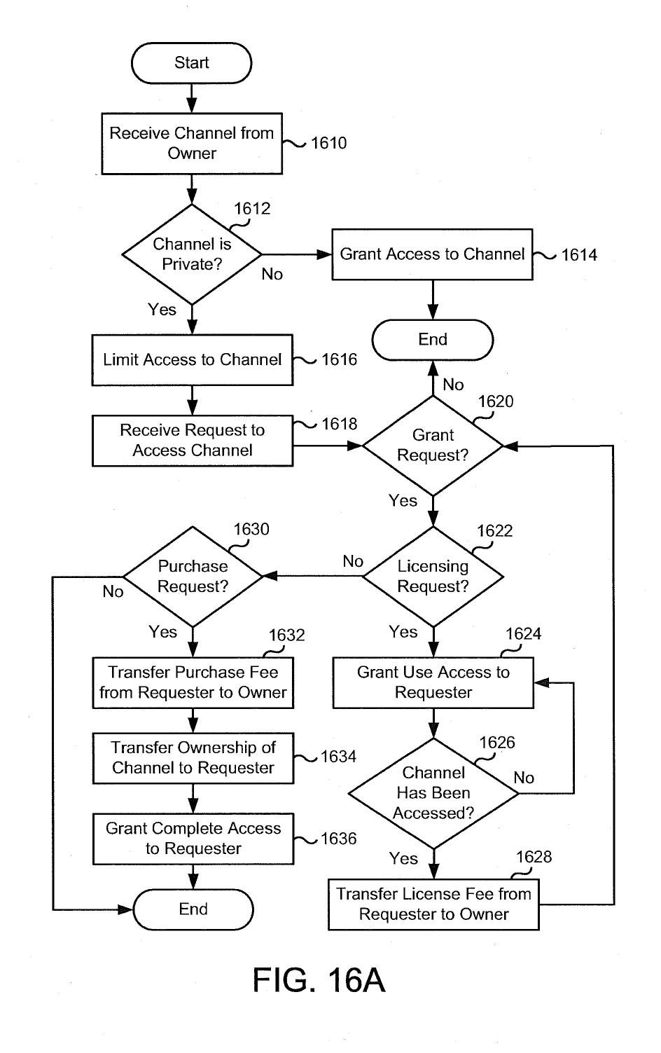

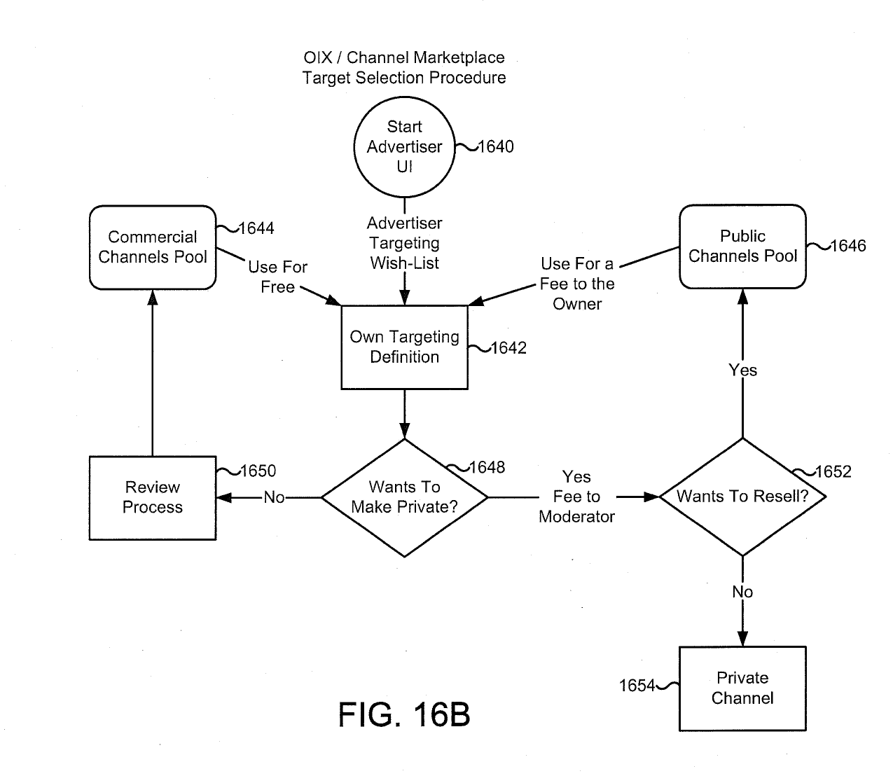

In this way, an advertiser can select, create, modify, and/or share a channel; select whether the channel is to be public or private; and receive revenue from the licensing or sale of their private channels. The media planning tool can enable some or all of these features as well as facilitating the transfer of monetary funds from one advertiser to another with regards to the licensing or purchase of channels. Note that a party such as a moderator, ISP, publisher, or other suitable party can host the media planning tool and facilitate the interaction of other parties relating to the various channel functions such as will be described in greater detail with reference to FIG. 16.

FIGS. 14 and 15 illustrate example tools that may be used by an advertiser to select, create, or modify a channel. As one example, the media planning tool may include a software application that provides the advertiser with the ability to control the channels applied to their particular advertising campaign. While the menus illustrated in FIGS. 14 and 15 provide a specific example of an interface of the media planning tool, it should be appreciated that these examples are non-limiting and that other examples and embodiments are possible. Note also that multiple parties can utilize the media planning tool to control the same campaign, thereby enabling collaboration among advertisers, publishers, ISPs, moderators, etc.

FIG. 14 illustrates a channel creation tool menu that can be used to create or modify one or more channels. In this particular example, an advertiser may seek to create a channel relating to airline travel. However, it should be appreciated that other channels relating to various categories or sub-categories may be created. For example, channels relating to a sports themed category may be created including sub-categories such as baseball, football, soccer. As another example, channels relating to an automotive themed category may be created including sub-categories such as racing, repair, reviews, etc. These channels may include various triggers associated with different categories and sub-categories, an example of which is illustrated in FIG. 15.

The creation of a channel or set of channels mapped onto a channel tree may include the selection of one or more context channels. For example, the context channel “Travel_Flights” selected from the pull down menu may be matched to clients that have retrieved web pages including contextual and/or behavioral information relating to travel or airline flights. Similarly, the context channel “Travel_Hotels” which has also been selected from the pull down menu may match clients that have retrieved web pages including contextual and/or behavioral information relating to travel or hotel stay. In this manner, any number of context channels may be added, where in this case two have been provided: “Travel_Flights” and “Travel_Hotels”. As will be described in greater detail with reference to FIG. 15, these context channels may be created or modified to include any number or type of contextual and/or behavioral information. For example, the “Travel_Flights” context channel may include keywords such as “flights”, “travel”, “tickets”, “airline”, etc.

The session channels can be used to qualify the selected contextual channels by requiring that the user visit a web page associated with the contextual channel a specified number of times within the browser session or login session. For example, as illustrated in FIG. 14, session channels may be matched to client users who have visited 2 or more web pages associated with the particular context channel. It should be appreciated that any suitable number of visits may be entered. In this manner an advertiser may select the threshold at which the channels will be matched to a particular client.

Note that various logic operators may be selected to enable further control over the channels and hence the delivery of tailored content. As illustrated by the example of FIG. 14, a pull down menu can used to select between the various logic operators such as “or” or “and”.

While the examples provided herein utilize “or” and “and” operators, it should be appreciated that any suitable logic operator may be used to control the creation of the channel and channel tree.

As illustrated in FIG. 14, the “or” logic operator has been selected for joining the two selected conditions of the session channels. As such, clients that have retrieved 2 or more web pages associated with the “Travel_Flights” or the “Travel_Hotels” context channels will be evaluated as a match by the content coordinator. Alternatively, the “and” operator may be selected so that clients may be matched where they have retrieved 2 or more web pages associated with both the “Travel_Flights” and the “Travel_Hotels” context channels.

In a similar manner, the behavioral channels can be controlled to qualify the channel based on the client's frequency of receiving content associated with the context channels. As one example, as illustrated in FIG. 14, the channel may be matched to the client where the client has retrieved at least 4 web pages associated with the “Travel_Flights” channel within the past 7 days and (as prescribed by the logic operator) where the client has also retrieved at least 3 web pages associated with the “Travel_Hotels” channel within the past 7 days. It should be appreciated that these conditions may be adjusted by the advertiser, for example, by changing the logic operator from an “and” to an “or”, or other suitable operator. Further, the conditions assigned to the behavioral channel such as the number of visits or number of days may be adjusted to achieve different client/content matching operations.

Similarly, demographic channels may be adjusted. Demographic channels may include channels that may be adjusted to reflect a particular demographic group such as age, sex, socio-economic statutes, among others, against which a client may qualify. For example, as illustrated in FIG. 14, a first demographic channel may include male/female operation, while a second channel may include an age range (e.g. 26-35). In this way, a client user fitting the demographic channels may be matched to content effective or suitable to their particular group. These demographic groups may be created by the advertiser or other party from market research information (e.g. Nielsen or Comscore) or may be created by third party data specialists on behalf of the advertiser utilizing the collaborative environment provided by the media planning tool. As yet another example, the demographic channels may be augmented and validated by online surveys directed to the client users.

It should be appreciated that any suitable number or type of channel creation tools may be used to create a set of channels represented by the channel tree, including, but not limited to the context channels, session channels, behavioral channels, and demographic channels. Any one of these channels can be added or removed from the channel tree by selecting the corresponding “remove” or “add” icons. Upon selection of one or more channel creation conditions from the channel creation tool, the channels may be mapped on the channel tree by selecting the “Submit” icon. In this way, the channel tree created by the channel creation tool menu illustrated in FIG. 14 may be used by the content coordinator to select content for delivery to the client.

A channel selection tool menu, an example of which is illustrated in FIG. 15, may be used to assign values to the particular contextual and/or behavioral information associated with the context channels described in FIG. 14. Continuing with the airline travel example, triggers may be created by selected contextual and/or behavioral information and assigned the particular information a corresponding value. For example, in a “URLs” field, one or more URLs may be added to the channel tree along with a value corresponding to the weighting of the particular contextual and/or behavioral information by the content coordinator. As illustrated in FIG. 15, the URL “www.ba.com” has been selected and assigned a value of 100, while “www.opodo.com” has been be selected and assigned a lesser value of 70. In other words, clients requesting the URL address www.ba.com may be matched to the particular channel by activating the trigger whereas clients requesting www.opodo.com, under at least some conditions, may not be matched.

In some embodiments, a sensitivity threshold may be assigned that designates the minimum value for a particular advertisement to be served to the client. The sensitivity threshold can be useful where the advertiser or other party desires that more than one trigger or combination of triggers are present before the channel is matched. For example, if the keyword value is 30 and the threshold is assigned to 100, then a minimum of 4 keywords will be necessary for the channel to be matched to the client. By increasing the sensitivity threshold, the specificity of the match may be increased, which may serve to increase the effectiveness of the content (e.g. advertisement) while reducing the number of matches and hence quantity of advertisements served. Conversely, reducing the sensitivity threshold may result in more matches and therefore a greater number of advertisements that are served. However, by decreasing the sensitivity threshold, the match may also become shallower, and the advertisements potentially less effective. As illustrated in FIG. 15, the sensitivity threshold has been set to “100”. Thus, a client requesting a URL address associated with www.ba.com may be matched (e.g. served a particular advertisement) since the value of the particular URL is equal to or greater than the sensitivity threshold. In contrast, the same client requesting www.opodo.com may not receive the same advertisement since the value of 70 is less than the sensitivity threshold of 100.

Other contextual and/or behavioral information may be added, selected, and/or assigned a corresponding value to create a trigger. For example, the “Search Terms” field includes the search term “flights” having an assigned value of 100. When a user searches for the term “flights” (e.g. via a web based search engine), the client may be matched to the channel and receive a corresponding advertisement since the assigned valve is equal to or greater than the assigned sensitivity threshold. Similarly, keywords on a web page may be selected and assigned a corresponding value via the “Keywords” field. For example, the keyword “London tours” has been added with an assigned value of 30. In the condition where a single keyword is located on a web page, a client may not be matched due to the value of 30 being less than the sensitivity threshold. In other words, other contextual and/or behavioral information may be required in this scenario for the trigger to be activated and for the channel to be matched to the client.

Further, contextual and/or behavioral information may be assigned negative values that can be deducted from the total value created by the other contextual and/or behavioral information. For example, the keyword “airplane crash” has been assigned a negative value of “−100”. Thus, where the client has search for the term “flights” which has a value of 100, has visited URL “www.opodo.com” which has a value of 70, and the web page includes the keyword “airplane crash” which has a value of “−100”, the client may not be matched to the channel since the summation of these three values are less than the sensitivity threshold of 100. In this manner, the match strength or total value for a particular web page may include the summation of the contextual and/or behavioral information selected with the channel selection tool. Further, it should be appreciated that these values may be modified by a weighting function as described above with reference to FIG. 12. For example, the values illustrated in FIG. 15 may represent the maximum value associated with the contextual and/or behavioral information, whereby the value is reduced as the web page associated with the contextual and/or behavioral information has been retrieved less recently by the client.

In some embodiments, the channel selection tool can enable the advertiser to create a list of banned contextual information that prevents the trigger from being activated and from the client being matched to the channel. For example, the keyword “airplane crash” may be assigned as banned contextual information that precludes the trigger from activating where the user has requested information including the keyword “airplane crash”. In this manner, an advertisement associated with the channel will not be displayed to the user and instead a default advertisement, if any, may be provided.

In this way, the media planning tool enables an advertiser to select, create, and/or modify channels. As such, it is possible for an advertiser to reach a desired audience or set of client users based on who they are (e.g. the demographic), what they have been doing (e.g. the session and behavior), and where they are now (e.g. the current context).

Furthermore, the channel definitions may be used to control how content is delivered to the end user. As discussed above, ISPs often provide different levels of service, with faster connections being allocated to higher-paying users or to specified premium content. Accordingly, a channel definition may include a specification that content is to be delivered using higher-bandwidth connections when they are available. Thus, an advertiser could use or create a channel to be activated only when a very likely purchaser is identified through contextual/behavioral information. In such a case, the advertiser presumably would be willing to pay the higher delivery charges incurred through use of the premium ISP connection, if such a connection is available for a particular user activating the channel.

FIG. 16A is a flow chart illustrating an example method of managing channel access among advertisers or other parties. At 1610 the channel may be received from the owner. For example, the owner (e.g. advertiser or other party) may submit or create a channel or set of channels that can be used by the content coordinator for selecting targeted content. The owner of the channel may select whether the channel is to be public or private. For example, if it is judged at 1612 that the channel is to be public, then access to the channel may be granted to other parties at 1614, wherein the channel may be viewed, used, or modify by other parties. Alternatively, if it is judged that the channel is to be private, then access to the channel may be limited at 1616. For example, only the owner of the channel may be able to access the channel while access may be denied to other parties unless it is enabled by the owner.

At 1618, a request to access the private channel may be received from a requesting party where it may be judged whether the requested access should be granted to the requester at 1620. For example, an advertiser may seek to use a private channel owned by another advertiser. If the owner does not wish to grant access to the requester, then the routine may end. Alternatively, if access is to be granted, then it may be judged at 1622 whether the request is a licensing request. For example, the channel owner may seek to license the use of their proprietary channel while maintaining the secrecy of the particular channel parameters. If the requester desires to license the use of the channel, some access to the channel may be granted at 1624. As one example, a use level of access may be enabled so that the requester can utilize the channel with the content coordinator in their particular advertising campaign. However, the requestor may be unable to identify the particular channel parameters, thereby maintaining the confidentiality of the proprietary channel.

At 1626, it may be judged whether the channel has been accessed (e.g. used) by the requestor and if so, the appropriate licensing fee may be transferred from the requester to the channel's owner as indicated at 1628. For example, the channel license may be structured on a per use basis, time use basis, etc. However, it should be appreciated that other licensing options may be used. Alternatively, if the channel has not been accessed at 1626, the routine may return to 1624 until the channel is accessed or used by the requester.

As an alternative to the licensing request, the requestor may seek to purchase the channel from the owner. In this scenario, it may be judged at 1630 whether the request is a purchase request. If the answer is yes, a corresponding purchasing fee may be transferred from the requestor to the owner at 1632 and the ownership and/or complete access of the channel may be granted to the requester. In other words, upon purchase of the channel, the requester may be granted complete access which can enable them to view the contents or configuration of the channel, to use the channel, to modify the channel, to re-sell the channel, to license the channel to other parties, and/or to select that the channel be made public.

Referring now to FIG. 16B, a schematic diagram of an open channel market is provided. Note that the approach of FIG. 16B can be used in addition to or as an alternative to the approach described above with reference to FIG. 16A. At 1640, an advertiser or other suitable party may initiate a user interface of the media planning tool at 1640 in order to create a content targeting definition (e.g. channel) for their advertising campaign at 1642. As one example, the user interface may include a software application provided by a moderator of the media planning tool. The content targeting definition created at 1642 may be based on one or more public channels received from a public channel pool 1644 or commercial channels (i.e. private channels) received from a commercial channel pool 1646. Note that the public and commercial channel pools can each include one or more channels. For example, the public channel pool may include a collection of channels that have been created and/or have used by other advertisers or third parties. In some embodiments, public channels may be used by the advertiser for free, while commercial channels may be used for a fee. These fees may be paid to the owner of the channel and/or the moderator. In alternative embodiments, use of the public channel may require a fee that is less than the fee for a commercial channel. For example, a smaller public channel fee may be paid by the advertiser to the moderator, while a larger commercial channel fee may be paid to the owner of the channel and/or moderator.

Upon creation of a channel or other suitable targeting definition at 1642, the advertiser creating the channel can select at 1648 whether the channel is to be private or public. If, for example, the channel is selected to be public, a review process may be initiated at 1650, before the public channel is added to the public channel pool at 1644. As one example, the review process may compare the channel to other channels within the pool and eliminate duplicative channels. As another example, the review process may examine the channel and attach identifiers to the channel so that it may be identified from the pool of public channels by other advertisers. As yet another example, the review process may return channels to the advertiser for modification, if there is a defect, before granting submission to the public channel pool. Note that in some embodiments, the moderator may pay a fee to the channel creator for granting public access to the channel at 1648.

Alternatively, if the channel is made private at 1648, then access to the channel by other advertisers may be limited. In some embodiments, a fee may be paid to the moderator by the advertiser in order to select the channel as a private channel. At 1652, the advertiser may select whether the private channel may resold for use by other advertisers. If the answer is no, then the channel may remain private, for example, where it may be used only by the advertiser that created the channel or other parties that the advertiser designates. Alternatively, if the advertiser desires to resell the channel at 1652, then their channel may be added to the commercial channel pool at 1646. Note that in some embodiments, a review process may be applied to the private channel before addition to the commercial channel pool, for example, as described with reference to 1650. Thus, other advertisers may utilize the media planning tool as described above to use the previously created private channel for a fee. Note that information associated with private channels may, under some conditions, be withheld from a third party that is using the channel for a fee so that the confidentiality of the channel contents may be maintained. In this manner, other advertisers may continue paying a fee to the channel owner for subsequent channel uses even after they have initially used the channel.

In this way, a moderator can utilize the media planning tool to facilitate an open market among advertisers for channels. Thus, parties may seek not only to create channels for their own advertising campaigns, but may license or sell their proprietary channels to other advertisers. By maintaining the confidentiality of the channels, the channel owner may derive revenue from their proprietary information and know-how via licensing the use of their channels to third parties.

Note that the approaches described with reference to FIGS. 16A and 16B may be performed by the media planning tool and facilitated by the moderator or other suitable party. Further, it should be appreciated that the term channel as described with regards to FIGS. 16A and 16B may include one or more channels that may be created or modified through the media planning tool and applied by the content coordinator.

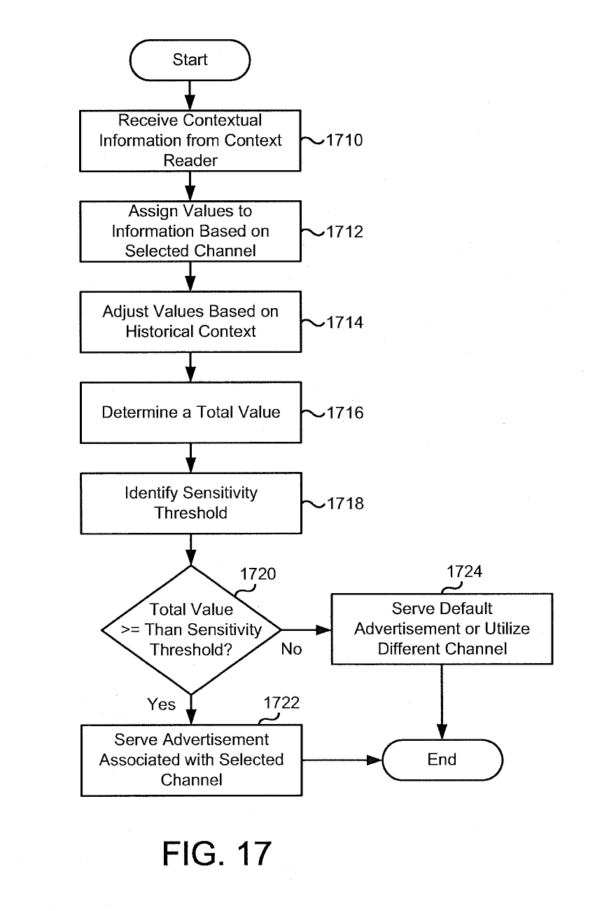

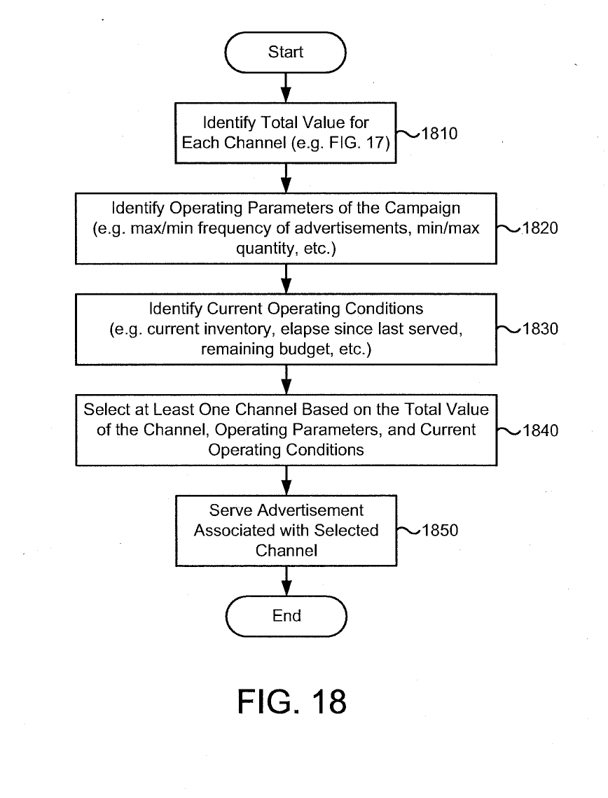

FIG. 17 is a flow chart illustrating an example routine that may be performed (e.g. by the content coordinator) to determine whether an advertisement or other content should be delivered to the client. At 1710, contextual and/or behavioral information may be received from the client via the context reader. At 1712, values may be assigned to the contextual and/or behavioral information responsive to the values set by the advertiser, for example, via the channel selection tool described above with reference to FIG. 14.

At 1714, the value of the contextual and/or behavioral information may be adjusted based on their historical context. For example, as described above with reference to FIGS. 13A and 13B, the value of contextual and/or behavioral information may be reduced or alternatively increased based on the relative historical proximity to the current web page or other content retrieved by the client. As one example, the value of a particular keyword located on a web page may decrease (e.g. based on a predefined function) with each successive web page retrieved by the client device after the particular web page where the keyword originated. As another example, contextual and/or behavioral information having negative values may increase in value (e.g. become more positive) as the associated web page becomes less recent.

At 1716, a total value of the contextual and/or behavioral information may be determined based on the assigned and/or adjusted values received from the client's context reader. The sensitivity threshold may be identified at 1718, for example, as set by the advertiser via the channel selection tool of FIG. 15. The total value determined at 1716 may be compared to the sensitivity threshold identified at 1718 determined at 1720 whether the total value is greater than or equal to the sensitivity threshold. If the answer at 1720 is yes, the content (e.g. advertisement) associated with the selected channel may be served to the client at 1722. For example, a link may be transmitted to the client device that is usable to retrieve the advertisement or other content. As another example, the content may be transmitted directly to the client device. Alternatively, if the answer at 1720 is no, default content may be served to the client or a different channel may be utilized. In this way, the approach described with reference to FIG. 17 may be applied to some or all of the channels of the advertiser's campaign. Note that the default advertisement or content may include no content, thereby enabling the publisher or ISP to utilize their own advertisement or content in place of the content provided by the content coordinator.

FIG. 18 is a flow chart illustrating an example routine that may be performed (e.g. by the content coordinator) to identify which channel of a plurality of channels should be selected, whereby the associated advertisement may be delivered to the client. At 1810, the routine may identify a total value for each channel as described, for example, with reference to 1710-1716 of FIG. 17. At 1820, the operating parameters of the campaign may be identified, including, but not limited to the maximum and/or minimum frequencies for the advertisement associated with each channel, the minimum and/or maximum quantity of advertisements to be served as associated with each channel, the minimum and/or maximum duration between the serving of advertisements associated with each channel, etc. Note that these parameters may be set by the advertiser via the media planning tool.

Returning briefly to FIG. 10, the channels selected, created, licensed, or modified by the advertiser may be configured as a channel tree as indicated at 1070. As illustrated, the advertiser may vary the channels (e.g. the behavioral channels 1072, the demographic channels 1074, etc.) associated with the channel tree. The media planning tool can also enable advertisers to define the parameters of the advertising campaigns as indicated at 1040. The matched channels 1030 are used to select content to be delivered to the client based on the campaign list 1040 as prescribed by the advertiser.

The media planning tool gives the advertiser the ability to run, extend, modify or renew campaigns that have been previously created. The media planning tool also enables the advertiser to achieve one or more of the following: upload creatives, define insertion orders and campaigns, set frequency limits for the serving of advertisements, select channels to run, set or identify the cost per click (CPC) or cost per action (CPA) to be paid, set geo-targeting, set time-of-day and day-of-week parameters for the serving of advertisements, set the duration (e.g. start and finish) of the campaign, set campaign goals (e.g. impressions, clicks, etc.). These and other parameters may be identified at 1820.

At 1830, the current operating conditions may be identified including the current inventory of advertisements served to some or all of the clients, elapsed time or number of page views since the advertisement was last served, the remaining advertising budget, etc. At 1840, at least one channel may be selected from the plurality of channels applied to the campaign (e.g. via the channel tree) based on one or more of the total value of each of the channels identified at 1810, the campaign operating parameters, and the current operating conditions. As one approach, the channel or channels with the highest total value may be selected in the case where the other operating parameters and conditions are substantially similar. However, if a first and a second channel have the same or similar total value, but an advertisement associated with the first channel has been served to clients relatively less often than the advertisement associated with the second channel, then the first channel may be selected. Alternatively, if a particular quota has already been met on the advertisement associated with the first channel, then the second channel may be selected.

According to still another approach, content may be selected based on multiple channel matches. In particular, assume user behavior leads to selection of channels 1, 2 and 3, with content A being targeted to channel 1 and content B being targeted to both channels 2 and 3. In such a case, if the combined value of channels 2 and 3 were higher, content B could be selected. This could be the case even where channel 1 had the highest value of the three channels.

At 1850, the advertisement associated with the selected channel may be served to the client. While the above example has been described with reference to advertising content, other content may be served to the client using a similar approach.

In some embodiments, the media planning tool can be used to provide the advertiser with estimates of the number of advertisements that may be served based on their particular channels and campaign parameters. As a first approach, a campaign that has already been performed and is being renewed or is similar to an existing campaign, an inventory estimation (e.g. prediction of goal performance) can be made available to the advertiser.

As a second approach, a campaign can be set to a virtual mode where the campaign is simulated by running it across the system to estimate its performance. For example, the virtual channels can be compared to other live channels utilizing a strategy similar to that described above with reference to FIGS. 17 and 18. The virtual mode can provide the advertiser with a realistic prediction of the number of advertisements served since the virtual advertisements compete with other live campaigns, using live client behavior, real frequency caps, and eCPM prioritization. As one example, the media planning tool may include an eCPM prioritization model that seeks to increase return on investment for the advertiser for direct response campaigns. Further, campaign performance information, such as clicks and actions, may be fed back into the channel tree to optimize the channels, enabling other campaigns to benefit. The optimization may be applied to channels that are public or channels that are private and can be licensed without displaying their content. The duration of the simulation may be as short as a few minutes, depending on the specificity of the targeting (e.g. channel configuration) and the level of statistical significance desired.

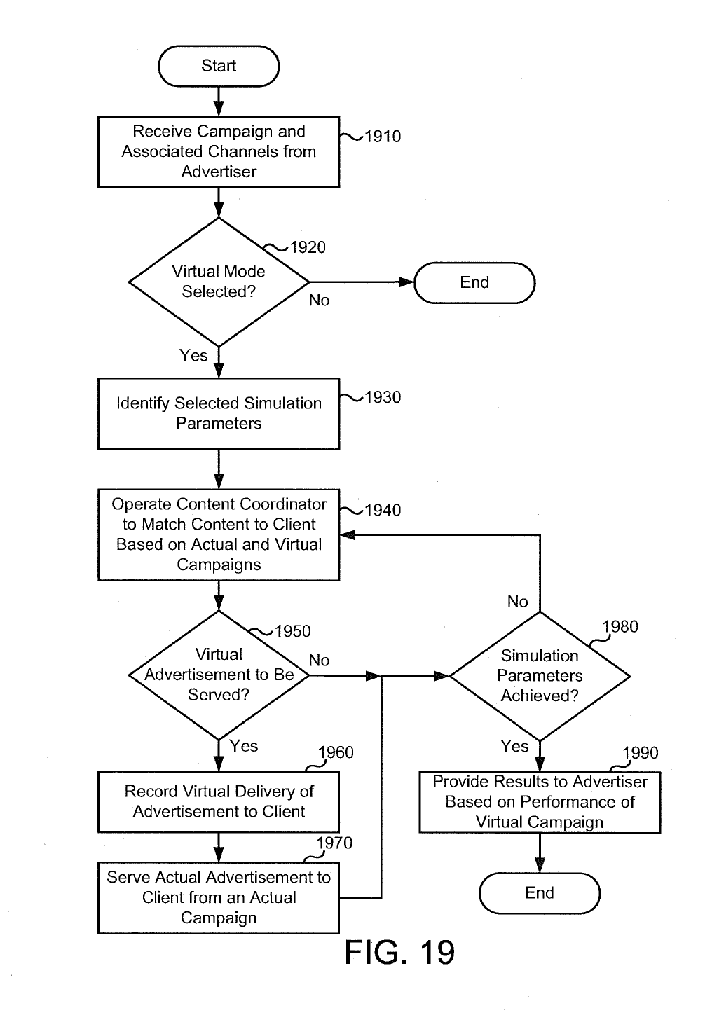

FIG. 19 is a flow chart illustrating an example simulation that may be facilitated by the media planning tool. At 1910, the campaign and associated channels may be received by the media planning tool. For example, an advertiser can create a new campaign including one or more channels for enabling the targeting of content to particular clients. At 1920, it may be judged whether the virtual mode has been selected by the advertiser. If the answer is no, the routine may end or may perform one or more of the approaches described above with reference to FIGS. 17 and 18 if the campaign is to be actually performed by the content coordinator.

Alternatively, if the answer at 1920 is yes, the simulation parameters may be identified at 1930. For example, the advertiser may prescribe the duration of the simulation, statistical confidence, or other suitable simulation parameters. At 1940, the simulation may be initiated where the content coordinator is operated to match content to an actual client based on actual campaigns (e.g. from the same advertiser and/or different advertiser) and the virtual campaign being simulated. In other words, the virtual campaign can be considered by the content coordinator along with other live campaigns.

At 1950, it may be judged whether the virtual advertisement is to be served. For example, as the channels associated with the virtual campaign are compared to the client's contextual and/or behavioral information along with channels associated with the actual or live campaigns (e.g. as described with reference to FIGS. 17 and 18), the virtual advertisement associated with the virtual campaign may be selected over advertisements associated with live campaigns. Therefore, if it is judged that the virtual advertisement is to be served to the client (e.g. the virtual channels were matched) then the simulated delivery of the virtual advertisement to the client may be recorded at 1960 and an actual advertisement associated with the next best matching channel from a live campaign may be actually delivered to the client at 1970.

Alternatively, if the answer at 1950 is no or from 1970, it may be judged whether the simulation parameters have been achieved. For example, if the simulation parameters have been set to provide at least a prescribed amount of data, then the route may judge whether the prescribed amount of data has been provided by the simulation. If the answer is no, the routine may return to 1940 where the virtual campaign continues to compete with live campaigns for the selection of advertising content or other suitable content. Alternatively, if the answer at 1980 is yes, then the results of the simulation may be provided to the advertiser or other party initiating the simulation. For example, the performance of the virtual campaign including the simulated delivery of virtual content via 1960 may be provided to the advertiser. In this manner, a campaign may be simulated in an actual competitive setting prior to setting the campaign to a live setting and actually running the campaign. If, for example, the advertiser is dissatisfied with the performance of their campaign in the virtual mode, the advertiser can modify the campaign or utilize a different campaign including the same or different channels to achieve a more desirable performance. Simulation may also help advertisers estimate the necessary advertising campaign budget, and/or control the rate at which the budgeted funds are expended.

Further, the media planning tool also can be configured to provide reporting to the advertiser. As one example, the media planning tool can provide performance reporting on the basis of campaign goals such as impressions, reach, clicks, actions, etc. It may be fully integrated with third party advertising systems such as DART and ATLAS, and can provide advanced metrics for video and bridge advertisements displayed to a client between domain navigations or between television programming.

The media planning tool can provide ISP specific controls. As one example, the ISP can choose to show bridge advertisements in addition to augmenting the performance of in-page advertisements shown by participating publishers. For bridge advertisements, the ISP may be provided the ability to control the delay before showing of the first bridge advertisement in a login session, the minimum time between bridge advertisements being shown, and/or the maximum number of bridge advertisements shown per client per day. Still other factors may be controlled. Thus, an ISP may be provided additional control over campaigns run through their system independent of the advertiser.

Publishers and ISPs who utilize bridge advertisements provide a location where advertising can be shown. As owners of that space, they can specify the type of advertising that they do not wish to show by utilizing the media planning tool. Similarly, they may review and/or veto actual advertisements that are run by the advertiser. As one example, publishers or ISPs can wrap existing advertising tags with an additional tag and specify an eCPM threshold for it. If the content coordinator can identify an advertisement of higher value than the threshold, the higher value advertisement may be shown. Otherwise, the original advertisement may be served to the client.

In some embodiments, content coordination may be selectively performed based on client preference. In particular, the content coordination system may provide a client with one or more opportunities to choose whether or not to participate in content coordination. By choosing to participate in content coordination, a client may receive targeted content based on anonymous contextual and/or behavioral information acquired during client network activity. Whereas, by choosing not to participate in content coordination, the client may receive untargeted content and anonymous contextual and/or behavioral information is not acquired during client network activity. The client participation request for content coordination may be generated in different forms based on various events.

Elective Client Participation

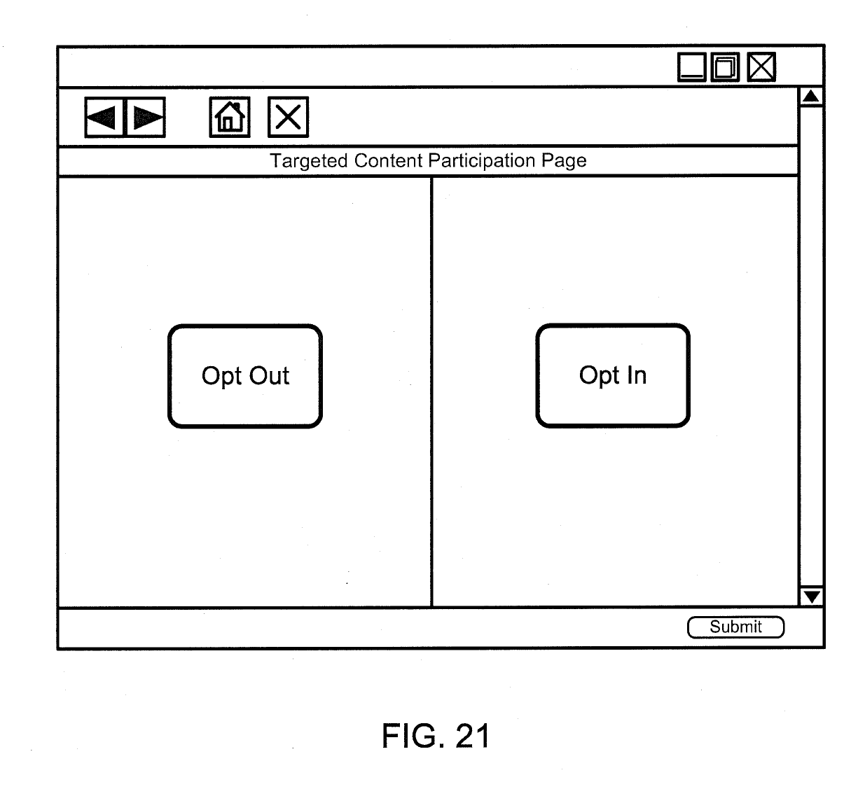

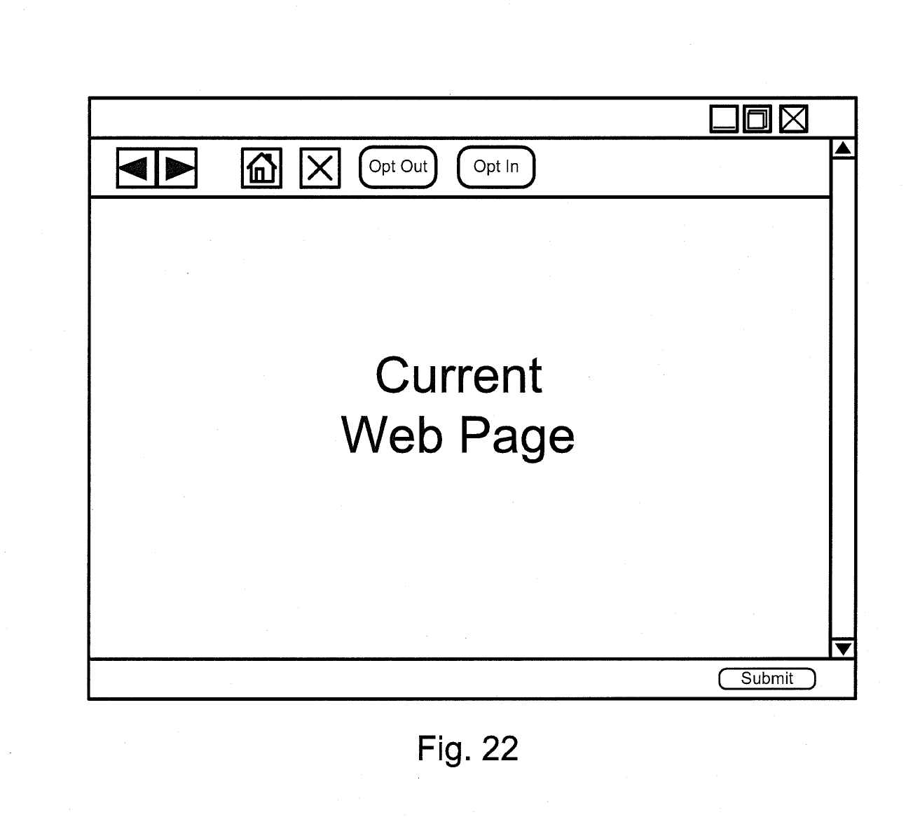

Referring to FIGS. 20-22, a non-limiting approach for receiving a client selection to participate in content coordination and sending content to the client based on the selection will be described. FIG. 20 illustrates a flow chart describing a routine for sending content to a client based on the client's decision to participate in content coordination. FIGS. 21-22 provide non-limiting example interfaces that facilitate client selection of whether or not to participate in content coordination.

Referring to FIG. 20, a client participation selection may be received by the content coordination system at 2010. Next at 2012, it may be judged whether the client has opted into participating in content coordination based on the selection received at 2010. If the answer is yes, the content selection system may send an “active” context reader (e.g. cookie) to the client that identifies the client as participating in content coordination at 2014.

Next at 2016, the content coordination system acquires anonymous contextual and/or behavioral information from the client. As discussed above, the contextual and/or behavioral information may be based on viewed website content and client behavior that is converted into various classifications of channels.

At 2018, the content coordination system may send targeted content to the client based on the information acquired at 2016. As discussed above, the transmitted content may be different media including print, audio, and/or video formats, for example. In some cases, the sent content may be advertising related. In one particular example, a specific advertisement may be sent to the client that matches the contextual and/or behavioral information channel acquired at 2016.

In some embodiments, the content coordination system may track the content sent to the client such that sending the same content repeatedly may be reduce or eliminated. Further, the tracking information may be contained in the client context reader.

Alternatively, if the answer at 2012 is no, the content selection system may send an “inactive” context reader (e.g. cookie) to the client that identifies the client as not participating in content coordination at 2020. The inactive context reader may communicate to the content coordination system that the client does not wish to participate in content coordination at the present time. Thus at 2022, the content coordination system ignores any anonymous contextual and/or behavioral information sent from the client and does not acquire (or track) any contextual and/or behavioral information. Next at 2024, the context coordination system sends untargeted content to the client. In this way, content may be provided to a client based on a selection to participate in content coordination.

Note that in some embodiments the context reader may be provided by other sources optionally (or additionally) to the content coordination system.

Further in some embodiments, the content coordination system may permit a client to choose various degrees of participation in content coordination. For example, a client may choose to participate in content coordination on a global scale. Namely, by choosing to participate a client may receive targeted content with content coordination during a network session or by choosing not to participate a client may receive untargeted content with no content coordination during the network session. FIG. 20 shows an exemplary global participation request page provided to the client. The global participation request page presents two options regarding participation in content coordination, namely “Opt Out” and “Opt In”. Selecting the “Opt Out” option disables content coordination for the client during network activity. Further, selecting the “Opt In” option initiates (or continues) content coordination for the client during network activity.

Note that the global participation request may be provided to a client at the initiation of each network session. Alternatively, the request may be provided during the inaugural network session of a client and/or during software configuration. In another example, the global participation request may be provided repeatedly based on a preset timetable.

Although the global request page is depicted as a web browser page, it should be appreciated that the global request page may be generated by other software applications and may be provided to a client at various times based on client activity.

As another example, a client may choose to participate in content coordination selectively during a network session. Specifically, a request may be provided numerous times throughout a network session and/or network activity enabling the client to choose when to initiate or disable content coordination and thus receive targeted content or untargeted content.

FIG. 22 depicts an exemplary content coordination selective participation tool bar. The tool bar includes “Opt Out” and “Opt In” radio buttons that facilitate selective participation in content coordination. A user may select one of the radio buttons to initiate or disable content coordination at any time during a network session. Alternatively, as another example, selective participation in content coordination may be provided in the form of a pop-up window each time a website is visited or where a prescribed website is visited. In some embodiments, the tool bar may further include participation preferences that a client may set to customize the content coordination participation experience. Specifically, a client may configure the tool bar so that targeted content is received only in selected channels.

It should be appreciated that a client may selectively participate in content coordination to various degrees through client network activity.

Further, note that while FIGS. 21-22 show participation selection tools embedded in a web browser, other suitable applications may be used to provide a client selection tool for participation in content coordination.

In some embodiments, a default setting may be selected for the client based on the particular service requested. For example, a default setting such as opt-in may be selected without requiring input from the client during a first condition, while an opt-out setting may be selected without requiring input from the client during a second condition. For example, the system may opt-out by default where the client is utilizing an online payment service, dating service, identity management tool, or other service where an increased level of privacy may be used.

Payments/Identity

Bringing client device users into closer contact with content having particular relevance to their interests, preferences, etc. is a significant advantage of the systems and methods described herein. As discussed above, ISPs can play an important role in this convergence by deploying a content-reading function in the network infrastructure. In addition, the ISP may be employed to provide advantages in the area of electronic transactions, with regard to payment and identity issues.

ISP-user relationships are typically established through a contract. For example, the user agrees to terms of service and to pay a monthly fee in exchange for the access (e.g., broadband internet access) provided by the ISP. Due to the contractual and economic relationship between the user and the ISP, the ISP has access to certain personal information of the user. Moreover, from the user's perspective, it will normally be preferable that such personal information not be shared with other networked entities. Indeed, there are often significant legal restrictions on the ability of an ISP to divulge information about its customers.

For example, referring to FIG. 1, while a given client C may be required to provide personal information to its ISP, the client probably would not want that information provided to other clients on that ISP, or shared with clients, advertisers, publishers or other entities connected to other ISPs. Despite this common desire to constrain the sharing of user information, users must commonly provide personal information to engage in online transactions. Billing information (e.g. credit card number and billing address) or other information commonly is required for downloads, to access specific content or websites, to purchase other goods and services, etc.

The ISP-user relationship may be extended in the present systems so that the ISP makes payments on behalf of the user. For example, when the user downloads a music file, subscribes to premium content on a website, performs research in a specialized database, purchases a product, etc., the charges for those activities would be processed by the ISP. According to one example, the ISP would advance payment to the third party on behalf of the client and the charges would be passed on to the client user in regular billing statements from the ISP. In another example, the user fills up a pre-paid account with the ISP, and the funds from that account are applied against online charges as they are incurred. Many other arrangements are possible—these are but illustrative examples. In many settings, the examples set forth above will enable the user to engage in the desired transaction without having to further disseminate his/her personal information.

In some embodiments, transactions may be facilitated by a client's ISP by way of a pubic key infrastructure (PKI). In this case, the ISP can provide trust delegation in online transactions, private correspondence, electronic signatures, etc. For example, the ISP can perform issuing functions of X.509 certificates or other suitable certificate format to third parties on behalf of the client. As the ISP and the client already have an established relationship, the ISP can perform these transactions with third parties (e.g. pay for online purchases) without requiring the client to submit their personal information to the third party. In some examples, a transaction may be completed with only some of the client's personal information being provided to the third party from the ISP. For example, the client's home address may be provided to a third party vendor by the ISP during select conditions so that goods may be shipped to the client. In this manner, a client user may be able to save time by not being required to re-enter their personal information for each third party vendor. In this manner, the ISP can serve as a central information repository for the client for facilitating online transactions or identity validations.

In some embodiments, an additional level or security or authentication may be utilized by the ISP for completing transactions with a third party on behalf of the client. For example, the client user may be prompted to enter their personal pin number or password in order to complete a transaction. Where the pin number or password is properly entered, the ISP can provide the required personal information to the third party. For example, where a user purchases video or audio content online, the user may be prompted to enter their personal pin number, whereby they are able to directly access the content without undue delays associated with the often requisite entry of personal information. In this case, the transaction may be handled by the ISP, whereby the client may be later billed by the ISP for one or more of these transactions in a consolidated and convenient manner.

As yet another example, the ISP may serve as an additional confirmation of the client user's information for other third parties. For example, where the user submits information to a third party (e.g. credit card, address, name, etc.), the third party can validate the information that is received from the user against the user's information stored at the ISP. In this manner, fraud or identity theft may be reduced or prevented where the ISP provides an authentication role.

As discussed throughout the present disclosure, the various systems and methods described herein may be combined and/or implemented in various different ways to serve varying needs. For advertisers or providers or goods/services, various system features may be combined to provide a powerful turn-key solution for enhancing the efficacy of online transactions. An example turn-key solution may include all, one, or various combinations of the following: (1) a mechanism for identifying customers, e.g., through use of the above-described channels and media planning tool; (2) a way to present the transaction opportunity by serving tailored content; (3) a mechanism for facilitating consummation of a transaction, through ISP-enabled payments; and (4) delivery of content via the infrastructure provided by the moderator entity.

Note that the example routines included herein can be used with various system configurations. The specific routines described herein may represent one or more of any number of processing strategies such as event-driven, interrupt-driven, multi-tasking, multi-threading, and the like. As such, various acts, operations, or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated acts or functions may be repeatedly performed depending on the particular strategy being used.

Further, the described acts may graphically represent code to be programmed into the computer readable storage medium. It will be appreciated that the configurations and routines disclosed herein are exemplary in nature, and that these specific embodiments are not to be considered in a limiting sense, because numerous variations are possible. The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method of providing targeted content to users through client devices each connected to a network through a service provider wherein a plurality of service providers serve as access points for connection to the network, the method comprising the steps of:
monitoring network activities of client devices by participation of more than one service provider;
collecting information derived from said network activities;
applying rules to said information to identify a user to receive targeted content; and
providing said targeted content to a client device associated with said identified user.

2. The method according to claim 1 wherein said step of collecting includes correlating said information derived from said network activities to said client devices and service providers.

3. The method according to claim 1 wherein said step of monitoring includes retrieving information selected from the group consisting of (i) identities of web pages/sites visited, (ii) contextual information for web pages/sites visited, (iii) terms entered in search engines, and (iv) frequency of site visits.

4. The method according to claim 1 further comprising retrieving a webpage requested by said client device wherein said step of monitoring includes retrieving contextual information of said web page, said contextual information selected from the group consisting of (i) page keywords, (ii) metadata embedded in a web page including meta tags, keyword, title, author, date, channel, description and robot tags, and (iii) links to other web pages.

5. The method according to claim 1 wherein said step of monitoring includes retrieving information stored in a Resource Description Framework (RDF).

6. The method according to claim 1 wherein said step of monitoring is performed through a plurality of Internet Service Providers (ISPs).

7. The method according to claim 1 wherein said step of monitoring on a proxy server through which web traffic with said client devices is routed.

8. The method according to claim 1 wherein said step of monitoring includes appending a context reader to a requested web page.

9. The method according to claim 8 further comprising a step of providing said requested web page and said context reader to a requesting client device.

10. The method according to claim 8 further comprising a step of performing a statistical analysis of said web page for contextual information selected from the set consisting of (i) keywords, (ii) URLs, (iii) search terms, (iv) user IDs, (v) meta tags, and (vi) code.

11. The method according to claim 8 further comprising a step of performing a contextual analysis of said web page for contextual information selected from the set consisting of (i) keywords, (ii) URLs, (iii) search terms, (iv) user IDs, (v) meta tags, and (vi) code.

12. The method according to claim 8 further comprising a step of performing a contextual analysis of multiple web pages to provide behavioral information.

13. The method according to claim 1 wherein said step of monitoring includes capturing data passing through said service providers to said client devices using a packet or network traffic sniffer.

14. The method according to claim 1 wherein said step of monitoring includes retrieving contextual information from information requests made by the clients devices.

15. The method according to claim 1 further comprising a step of performing a statistical analysis of said network activity.

16. The method according to claim 15 wherein said step of performing said statistical analysis of said network activity provides contextual and behavioral information.

17. The method according to claim 1 further comprising a step of performing a contextual analysis of said network activity.

18. The method according to claim 17 wherein said step of performing said contextual analysis of said network activity provides contextual and behavioral information.

19. The method according to claim 1 wherein said step of collecting information includes transmitting said information to an advertising server.

20. The method according to claim 1 wherein said step of collecting information includes tagging said information with service provider identification data.

21. The method according to claim 1 wherein said step of providing said targeted content to said client devices includes retrieving targeted content including advertising from an advertising server.

22. The method according to claim 1 wherein said step of providing said targeted content to said client devices includes inserting content including advertising into web pages requested by the client devices.

23. The method according to claim 1 wherein said step of providing said targeted content to said clients includes providing a link corresponding to a location of a server where selected advertising content may be retrieved.

24. A method of providing desired targeted content to a client comprising the steps of:
generating an information request;
routing said information request to a proxy;
requesting information, identified by said information request, from a server;
returning said requested information to said proxy;
applying a context reader to said requested information to obtain context information from said requested information;
sending said context information to a moderator;
selecting desired targeted content in response to said context information together with other information gathered about a user; and
providing said desired targeted content to the client.
